(19) United States
(12) Patent Application Publication
(10) Pub. No.: US 2006/0101402 A1
(43) Pub. Date: May 11, 2006

(54) Method and systems for anomaly detection

(76) Inventors: William L. Miller, Ada, MI (US); Dragan Djurdjanovic, Ann Arbor, MI (US); Jianbo Liu, Ann Arbor, MI (US)

Correspondence Address: Erik G. Swenson;Merchant & Gould P.C., P.O. Box 2903, Minneapolis, MN, 55402-0903, US

(21) Appl. No.: 10/967,102

(22) Filed: Oct. 15, 2004

(51) Int. Cl. G06F 9/44

(52) U.S. Cl. 717/124

(57) ABSTRACT

A system for detecting anomalies includes a first hardware system and a first run-time environment. The first hardware system generates outputs. The first run-time environment has a bi-directional link to an integrated development environment. The first run-time environment includes a first control system, a first diagnostic agent, and a second diagnostic agent. The first control system controls the hardware system through control inputs to the hardware system. The first diagnostic agent detects anomalies in the hardware system. The second diagnostic agent detects anomalies in the control system. A method of detecting anomalies in a system including an integrated development environment and a run-time environment bi-directionally linked by a link includes partitioning the run-time environment into at least one operational region; learning normal operating behaviors within the operational region; monitoring current operating behaviors within the operational region during operation of the system; comparing the current operating behaviors to the normal operating behaviors; detecting anomalies when a deviation exists between the current operating behaviors and the normal operating behaviors; tracing the anomalies back to the integrated development environment; and identifying the anomalies in the integrated development environment based on the tracing of the anomalies.

### TECHNICAL FIELD

The present invention relates to software and systems, and more particularly to anomaly detectors in run-time environments.

### BACKGROUND

In the current paradigm of product development, the quality of a product, its production, and its service is mainly designed, tested, and implemented during development. Errors in a product, its production, or its service are identified during development and corrected. Once a product is released, it is difficult to find remaining quality problems.

In the automotive industry, warranty repair is expensive and can consume a company's profits. Engineering is the root cause of more than fifty percent of warranty repair costs. Software, operating within the vehicle, is a core part of the engineering problem. Because engineering is often the root cause of the problem, swapping parts during the repair will not solve the problem. Therefore, improvements are desirable.

### SUMMARY

In accordance with the present invention, the above and other problems are solved by the following:

In one aspect of the present invention, a system for detecting anomalies includes a first hardware system and a first run-time environment. The first hardware system generates outputs. The first run-time environment has a bi-directional link to an integrated development environment. The first run-time environment includes a first control system, a first diagnostic agent, and a second diagnostic agent. The first control system controls the hardware system through control inputs to the hardware system. The first diagnostic agent detects anomalies in the hardware system. The second diagnostic agent detects anomalies in the control system.

In another aspect of the present invention, a method of detecting anomalies in a system including an integrated development environment and a run-time environment bi-directionally linked by a link is disclosed. The method includes partitioning the run-time environment into at least one operational region; learning normal operating behaviors within the operational region; monitoring current operating behaviors within the operational region during operation of the system; comparing the current operating behaviors to the normal operating behaviors; detecting anomalies when a deviation exists between the current operating behaviors and the normal operating behaviors; tracing the anomalies back to the integrated development environment; and identifying the anomalies in the integrated development environment based on the tracing of the anomalies.

In another aspect of the present invention, a computer program product readable by a computing system and encoding instructions for a computer process for detecting anomalies in a system including an integrated development environment and a run-time environment bi-directionally linked by a link is disclosed. The computer program product includes partitioning the run-time environment into at least one operational region; learning normal operating behaviors within the operational region; monitoring current operating behaviors within the operational region during operation of the system; comparing the current operating behaviors to the normal operating behaviors; detecting anomalies when a deviation exists between the current operating behaviors and the normal operating behaviors; tracing the anomalies back to the integrated development environment; and identifying the anomalies in the integrated development environment based on the tracing of the anomalies.

In yet another aspect of the present invention, a system for detecting anomalies in a system including an integrated development environment and a run-time environment bi-directionally linked by a link is disclosed. The system includes a partition module, a learn module, a monitor module, a compare module, a detect module, a trace module, and an identify module. The partition module partitions the run-time environment into at least one operational region. The learn module learns normal operating behaviors within the operational region. The monitor module monitors current operating behaviors within the operational region during operation of the system. The compare module compares the current operating behaviors to the normal operating behaviors. The detect module detects anomalies when a deviation exists between the current operating behaviors and the normal operating behaviors. The tracing module traces the anomalies back to the integrated development environment. The identify module identifies the anomalies in the integrated development environment based on the tracing of the anomalies.

The invention may be implemented as a computer process; a computing system, which may be distributed; or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the present invention and its scope may be obtained from the accompanying drawings, which are briefly described below, from the following detailed descriptions of presently preferred embodiments of the invention and from the appended claims.

### BRIEF DESCRIPTION OF THE DRAWINGS

Referring now to the drawings in which like reference numbers represent corresponding parts throughout:

FIG. 1 is a schematic representation of methods and systems for learning model-based lifecycle diagnostics, according to an exemplary embodiment of the present disclosure;

FIG. 2 is a schematic representation of a computing system that may be used to implement aspects of the present disclosure;

FIG. 3 is a block diagram of a the development of a product; according to an exemplary embodiment of the present disclosure;

FIG. 4 is a schematic representation requirements associated with a wicked problem, according to an exemplary embodiment of the present disclosure;

FIG. 5 is a schematic representation of methods and systems for learning model-based lifecycle diagnostics, according to an exemplary embodiment of the present disclosure;

FIG. 6 is a schematic representation of methods and systems for learning model-based lifecycle diagnostics, according to an exemplary embodiment of the present disclosure;

FIG. 7 illustrates an example graphic user interface, according to an exemplary embodiment of the present disclosure;

FIG. 8 is a schematic illustrating a distributed system, according to an exemplary embodiment of the present disclosure;

FIG. 9 is a process diagram illustrating a vehicle product development, according to an exemplary embodiment of the present disclosure;

FIG. 10 is a process diagram illustrating the spiral lifecycle process, according to an exemplary embodiment of the present disclosure;

FIG. 11 is a process diagram illustrating the spiral lifecycle process, according to an exemplary embodiment of the present disclosure;

FIG. 12 is a process diagram illustrating the vehicle development phase, according to an exemplary embodiment of the present disclosure;

FIG. 13 is a process diagram illustrating how the lifecycle method progresses through requirements, according to an exemplary embodiment of the present disclosure;

FIG. 14 is a process diagram illustrating how the lifecycle method applies a spiral sub process, according to an exemplary embodiment of the present disclosure;

FIG. 15 is a process diagram illustrating how the lifecycle method is applied, according to an exemplary embodiment of the present disclosure;

FIG. 16 is a process diagram illustrating how the lifecycle method progresses, according to an exemplary embodiment of the present disclosure;

FIG. 17 is a process diagram illustrating how the lifecycle method applies a spiral sub process, according to an exemplary embodiment of the present disclosure;

FIG. 18 is a process diagram illustrating how the lifecycle method is applied in the spiral sub process, according to an exemplary embodiment of the present disclosure;

FIG. 19 is a system diagram, according to an exemplary embodiment of the present disclosure;

FIG. 20 illustrates how the lifecycle method links the levels together, according to an exemplary embodiment of the present disclosure;

FIG. 21 is a process diagram illustrating an anomaly detection system, according to an exemplary embodiment of the present disclosure;

FIG. 22 is a schematic representation of an anomaly detection system, according to an exemplary embodiment of the present disclosure;

FIG. 23 is a schematic representation of a gasoline engine model system, according to an exemplary embodiment of the present disclosure;

FIG. 24 is a schematic representation of an integrated control system, gasoline engine vehicle model system, and anomaly detectors, according to an exemplary embodiment of the present disclosure;

FIG. 25 is a schematic representation of an anomaly detection system, according to an exemplary embodiment of the present disclosure;

FIG. 26 is a process flow diagram of an anomaly detection system, according to an exemplary embodiment of the present disclosure; and

FIG. 27 is a process flow diagram of an anomaly detection system according to an exemplary embodiment of the present disclosure.

### DETAILED DESCRIPTION

In the following description of preferred embodiments of the present invention, reference is made to the accompanying drawings that form a part hereof, and in which is shown by way of illustration specific embodiments in which the invention may be practiced. It is understood that other embodiments may be utilized and changes may be made without departing from the scope of the present invention.

The present disclosure describes methods and systems for learning model-based lifecycle software and systems. More particularly, the software and systems are self-diagnosing and typically include embedded diagnostic agents. These diagnostic agents can be include anomaly detection agents and knowledge-based agents.

The systems can include an integrated development environment (IDE) and a run-time environment (RTE) linked together. The IDE contains a set of development tools linked within the IDE and linked to the RTE. The RTE includes a number of diagnostic agents linked within the RTE and linked to the IDE. Thereby, the development tools and the diagnostic agents communicate with each other.

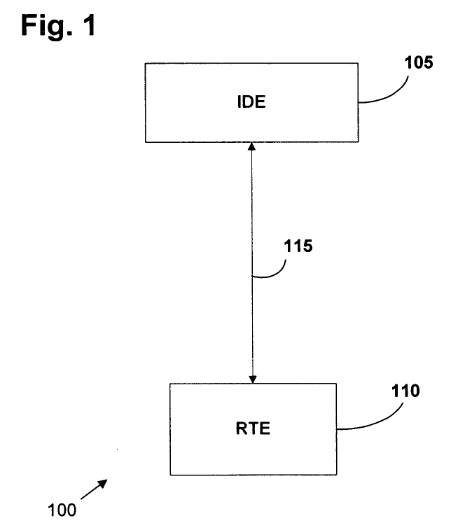

Referring now to FIG. 1, an example schematic representation of a learning model-based lifecycle system 100 is illustrated. An IDE 105 includes a set of software tools, or agents, linked within the IDE 105. A RTE 110 includes another set of software agents linked within the RTE 110. The IDE 105 and the RTE 110 are linked via link 115.

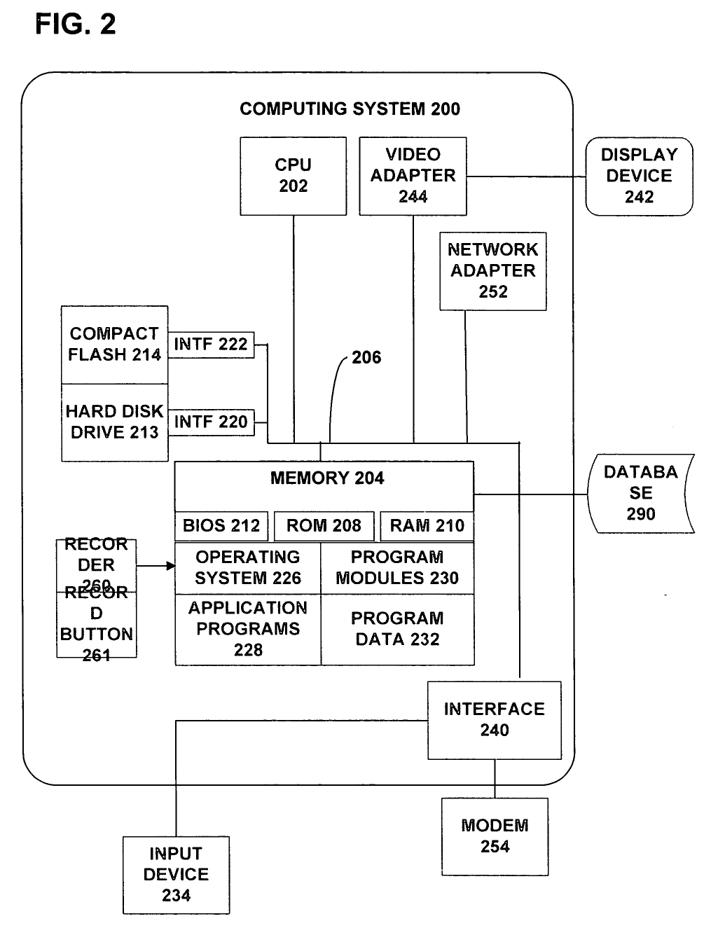

FIG. 2 and the following discussion are intended to provide a brief, general description of a suitable computing environment in which the invention might be implemented. Although not required, the invention is described in the general context of computer-executable instructions, such as program modules, being executed by a computing system. Generally, program modules include routines, programs, objects, components, data structures, etc. that perform particular tasks or implement particular abstract data types.

Those skilled in the art will appreciate that the invention might be practiced with other computer system configurations, including handheld devices, palm devices, multiprocessor systems, microprocessor-based or programmable consumer electronics, network personal computers, minicomputers, mainframe computers, and the like. The invention might also be practiced in distributed computing environments where tasks are performed by remote processing devices that are linked through a communications network. In a distributed computing environment, program modules might be located in both local and remote memory storage devices.

Referring now to FIG. 2, an exemplary environment for implementing embodiments of the present invention includes a general purpose computing device in the form of a computing system 200, including at least one processing system 202. A variety of processing units are available from a variety of manufacturers, for example, Intel or Advanced Micro Devices. The computing system 200 also includes a system memory 204, and a system bus 206 that couples various system components including the system memory 204 to the processing unit 202. The system bus 206 might be any of several types of bus structures including a memory bus, or memory controller; a peripheral bus; and a local bus using any of a variety of bus architectures.

Preferably, the system memory 204 includes read only memory (ROM) 208 and random access memory (RAM) 210. A basic input/output system 212 (BIOS), containing the basic routines that help transfer information between elements within the computing system 200, such as during start-up, is typically stored in the ROM 208.

Preferably, the computing system 200 further includes a secondary storage device 213, such as a hard disk drive, for reading from and writing to a hard disk (not shown), and/or a compact flash card 214.

The hard disk drive 213 and compact flash card 214 are connected to the system bus 206 by a hard disk drive interface 220 and a compact flash card interface 222, respectively. The drives and cards and their associated computer-readable media provide nonvolatile storage of computer readable instructions, data structures, program modules and other data for the computing system 200.

Although the exemplary environment described herein employs a hard disk drive 213 and a compact flash card 214, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 213, compact flash card 214, ROM 208, or RAM 210, including an operating system 226, one or more application programs 228, other program modules 230, and program data 232. A user may enter commands and information into the computing system 200 through an input device 234. Examples of input devices might include a keyboard, mouse, microphone, joystick, game pad, satellite dish, scanner, digital camera, touch screen, and a telephone. These and other input devices are often connected to the processing unit 202 through an interface 240 that is coupled to the system bus 206. These input devices also might be connected by any number of interfaces, such as a parallel port, serial port, game port, or a universal serial bus (USB). A display device 242, such as a monitor or touch screen LCD panel, is also connected to the system bus 206 via an interface, such as a video adapter 244. The display device 242 might be internal or external. In addition to the display device 242, computing systems, in general, typically include other peripheral devices (not shown), such as speakers, printers, and palm devices.

When used in a LAN networking environment, the computing system 200 is connected to the local network through a network interface or adapter 252. When used in a WAN networking environment, such as the Internet, the computing system 200 typically includes a modem 254 or other means, such as a direct connection, for establishing communications over the wide area network. The modem 254, which can be internal or external, is connected to the system bus 206 via the interface 240. In a networked environment, program modules depicted relative to the computing system 200, or portions thereof, may be stored in a remote memory storage device. It will be appreciated that the network connections shown are exemplary and other means of establishing a communications link between the computing systems may be used.

The computing system 200 might also include a recorder 260 connected to the memory 204. The recorder 260 includes a microphone for receiving sound input and is in communication with the memory 204 for buffering and storing the sound input. Preferably, the recorder 260 also includes a record button 261 for activating the microphone and communicating the sound input to the memory 204.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

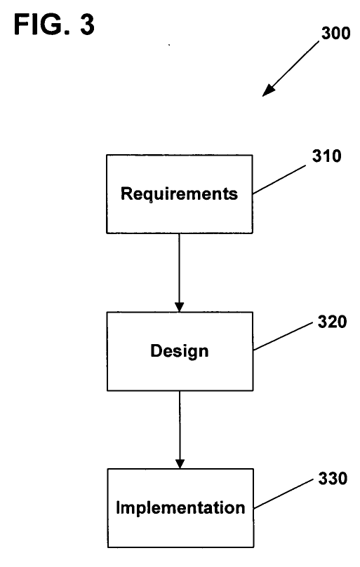

FIG. 3 is a block diagram illustrating a development system 300, which can include software and development tools. The development system 300 includes three basic types of components in the development of a product, for example, a vehicle. Block 310 is the requirements component. The first step in product and system development uses the requirements component. The requirements component defines what the product and system will include. Block 320 is the design component. After the requirements for the product and system are determined, the product and system are designed to conform to those requirements. Block 330 is the implementation component. After the product and system are designed, the product and system are manufactured according to the design component and put into service. The system can also include enterprise applications for supply and service chain integration. In addition, the system can include run-time application services including telecommunications and operations infrastructure and vehicles.

Using a vehicle as an example, a car manufacturer decides to make a new model X car with systems for learning model-based lifecycle diagnostics. At block 310, the requirements for the X car and systems are determined. For example, the X car should be a sedan having a certain payload, acceleration, and should not exceed $20,000. The system should reduce warranty repair costs and improve customer satisfaction.

At block 320, the X car and the systems are designed according to those requirements. The frame and suspension of the car are designed to carry the required payload, the power train is designed or chosen based on the gross vehicle weight and the acceleration requirement, and the rest of the X car is designed to not exceed $20,000. For example, knowing the X car should not exceed $20,000, an engineer may decide to choose an engine that barely meets the acceleration requirement and would not choose an engine that would greatly exceed the acceleration requirement. The system could be designed using web services with an imbedded web platform to run on a three-tier architecture consisting of servers, telematics, and electronics embedded in the vehicle. The system can have a distributed database to enable servers to be located throughout the supply and service chain. The system can include development, manufacturing, and service tools.

At block 330, the X car and the systems are implemented, i.e. manufactured and put into service, according to the design. Implementation deploys the software and hardware throughout the three-tier architecture in the supply and service chains.

Typically, software is utilized in each step of the product and system lifecycle, which includes product and system development, production, and service. Requirements management (RM) processes of vehicles and systems requires tools to facilitate collaboration among people in the supply and service chain. Currently, requirements management (RM) software uses model-driven, objected-oriented (OO) tools based on information authored and collected by people. Since the RM is dependant on the information input into it, the RM is limited. Therefore, these typical RM tools are inflexible and cannot autonomously recognize errors without intervention from people. Some RM tools are based on knowledge agents, giving it the ability to learn and recognize errors. Such RM tools are also inflexible.

In the requirements step, there are two classes of knowledge problems that determine the type of product and system to be analyzed, and then the tools and processes required for development, production, and service. These two classes of problems include “tame” and “wicked” problems. Most problems are tame and can be solved with a stage-gate, linear process and information-based tools. Developing the requirements for a system to manage wicked problems requires a spiral process and knowledge-based tools.

Wicked problems are composed of a linked set of issues and constraints, and do not have a definitive statement of the problem itself. The problem (and therefore the requirements for designing a solution) cannot be adequately understood until iterative prototypes representing solution candidates have been developed. Within the primary overall development process, which is linear, a secondary spiral process for iterative prototypes is required. The spiral process involves “rolling out” a portion of the software at a time while another portion is being developed. The software engineering community has recognized that a spiral process is essential for rapid, effective development.

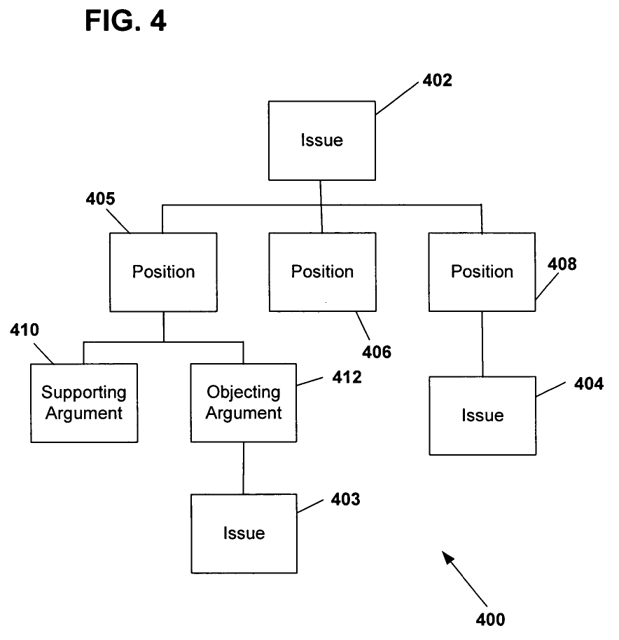

An example of a wicked problem is the design of a car and the diagnostics for the car. The “wicked” terminology was introduced by Horst Rittel in 1970. Rittel invented a technology called issue-based information systems (IBIS) to help solve this new class of problems. Wicked problems look very similar to ill-structured problems, but have many stakeholders whose views on the problem may vary. Wicked problems must be analyzed using a spiral, iterative process, and the ideas, such as requirements associated with the problem, have to be linked in a new paradigm 400, illustrated in FIG. 4.

Referring to FIG. 4, the three key IBIS entities are (1) issues 402, 403, 404, or questions, (2) positions 405, 406, 408, or ideas, that offer possible solutions or explanations of the issues, and (3) arguments 410, 412, or the pro's and con's. All three entities can be linked by relationships such as supports, objects-to, is—suggested—by, responds to, generalizes, specializes, replaces, and others. The visualization of IBIS becomes a graph or a network. IBIS builds a bridge between design and argumentation or the expressed dialog of ideas that forms the core of knowledge management.

IBIS is a graphical language with a grammar, or a form of argument mapping. Applying IBIS requires a skill similar to the design of experiments (DOE). Jeffrey Conklin (http://cognexus.org/id17.htm) pioneered the application of graphical hypertext views for IBIS structures with the introduction of graphical IBIS or gIBIS. The strength of IBIS, according to Conklin, stems from three properties: (1) IBIS maps complex thinking into analytical structured diagrams, (2) IBIS exposes the questions that form the foundation of knowledge, and (3) IBIS diagrams are much easier to understand than other forms of information.

Compsim LLC has extended IBIS in several ways. In their IBIS tool architecture, ideas can be specified in either the form of a text outline or a tree structure of nodes. Ideas of a given level can have priorities and weights to change the ordering of the display of ideas. Priorities can be easily edited in a variety of graphical ways. A unique decision making mechanism mimics human thinking with relative additions and subtractions for supporting negating arguments. The IBIS logic is captured as XML definitions and is used to build linked networks of knowledge-based agent networks. Compsim calls this agent structure knowledge enhanced electronic logic (KEEL). The agents execute an extended form of the IBIS logic.

The current field that contains IBIS is called computer-supported argument visualization (CSAV). Related fields that apply CSAV are computer-supported cooperative work (CSCW) and computer-mediated communication (CMC), which helped spawn the Internet. CMC tools include Microsoft's NetMeeting™ product.

Argument visualization is a key technology for defining the complex relationships found in requirements management, which is a subset of knowledge management (KM). One of the principles for KM is found in constructivist learning theory, which requires the negotiated construction of knowledge through collaborative dialog. The negotiation involves comparative testing of ideas. The corresponding dialog with visualization of ideas creates the tacit knowledge that comprises the largest part of knowledge as opposed to the explicit part of knowledge directly linked to information. Tacit knowledge is essential for shared understanding.

IBIS is a knowledge-based technology. IBIS tools for requirements management such as Compenium™ or QuestMap™ (trademarks of GDSS, Inc.) are distinctly different from object-oriented (OO) framework tools for RM such as Telelogics's Doors™ or IBM's Requisite-Pro™. Wicked problems cannot be easily defined such that all stakeholders agree on the problem or the issues to be solved. There are tradeoffs that cannot be easily expressed in OO framework with RM tools. IBIS allows dyadic, situated scenarios to define requirements. IBIS allows the requirements to be simulated. IBIS can sense those situations and determine which set of requirements is appropriate or whether the requirements even adequately apply to the situation.

In summary, current RM tools have limitations. OO RM tools enable traceability between requirements, design, and implementation during development, but not during the production or service deployment phases. OO RM tools are not knowledge-based and cannot easily handle ill-structured, wicked problems with multiple stakeholder views that conflict with different weighted priority ranking of those views expressed as the pro's and con's of argumentation. IBIS RM tools overcome most of those limitations but do not develop traceable requirements for a system design.

Both OO RM and IBIS RM tools recognize that the relationship between ideas as expressed in text alone is not clear without additional structure such as an outline with an associated hierarchy. Network structures such as those made possible by hypertext technology can be traced back to Vannevar Bush and his 1945 article As We May Think. In 1962, Douglas Englebart defined a framework for cognitive augmentation with tools in his report from the Stanford Research Institute, Augmenting Human Intellect: A Conceptual Framework. The result of Englebart's research and development work was the development of the modem windows, icon, mouse, and pointer (WIMPT) graphical user interface (GUII) and an early implementation of hypertext-based tools.

Round-trip engineering for OO, or model-driven software development, is a source code for implementation that is traceable back to elements of design and requirements. The round-trip is between requirements, design, and implementation as source code and then back to design and requirements. Since round-trip engineering currently occurs only during development and only within certain segments of the IDE, model errors that appear in the RTE after development cannot be traced back to root causes in requirements, design, or implementation. A segmented IDE might consist of four quadrants. These quadrants contain methods and tools for (1) enterprise applications in a system, (2) embedded software for the vehicles, (3) telematics for the vehicle, and (4) service systems for the vehicle.

Frequently, the OO model is defined using a unified modeling language (UML). UML is a third generation OO graphical modeling language. The system model has structural, behavioral, and functional aspects that interact with external users called actors as defined in use cases. A use case is a named capability of the system. System requirements typically fall into two categories: functional requirements and non-functional or Quality of Service (QoS) requirements.

Functional means what the system should do. QoS means how well or the performance attributes of the function. In common usage, functional can imply both functional and performance. The structural aspect defines the objects and object relations that may exist at run-time. Subsystems, packages, and components also define optional structural aspects. The behavioral aspect defines how the structural elements operate in the run-time system. UML provides state-charts (formal representation of finite-state-machines) and activity diagrams to specify actions and allowed sequencing. A common use of activity charts is specifying computational algorithms. Collections of structural elements work together over time as interactions. Interactions are defined in sequence or collaboration diagrams.

The requirements of a system consisting of functional and QoS aspects are captured typically as either one or both of two ways: (1) a model is use cases with detailed requirements defined in state charts and interaction diagrams, or (2) specifications as text with or without formal diagrams such as sequence diagrams that attempt to define all possible scenarios of system behavior.

Round-trip engineering traces OO requirements through OO design into an OO implementation that includes the OO source code for software. This round-trip occurs only in certain segments of the IDE, which are OO IDE segments, and only during development. Currently, there is no round-trip traceability between an RTE and an IDE during development, production, and service. Round-trip engineering has been extended to use a meta-model rather than require obtrusive source code markers, but extended round-trip engineering still occurs only within certain segments of the IDE during development.

Model-based diagnostics is a state-of-the-art method for fault isolation, which is a process for identifying a faulty component or components of a vehicle and a system that is not operating properly in compliance with operating parameters specified as part of the vehicle and system's implementation model. Model-based diagnostics suffers from the limitations of assuming that the model has no errors and accurately represents all the operating scenarios of the system. The operating scenarios of the system include all expected faults.

If an adequate amount of observable information from the vehicle is available at run-time, model-based diagnostics can determine the root cause for previously known and expected failure modes predicted by an expanded model that includes both normal and failure modes. The expanded model is used to simulate and record the behavior resulting from all possible single component failures, then combinations of multiple component failures. When failure behavior is observed, a sequence of pre-determined experiments can be performed to determine the root cause.

Faults in the vehicle and system's requirements or design and implementation models are mainly detected after development by users who may complain and have their complaints analyzed by service technicians and then possibly by engineers. Situations that led to the complaints are frequently not easily identified and reproducible. The process of fault isolation or root cause determination generally begins at detection of abnormal system behavior and attempts to identify the defective and improperly operating component or components. These components perform some collection of functions in the system. The components are frequently designed to be field replaceable hardware units that may contain software. However, the failure model assumed in current practice considers functional failure modes of the replaceable component and does not determine whether the failure inside the component or components is a hardware or a software failure. If the failure is in software, then the failure is a model failure at the requirements, design, or implementation level. Replacing the hardware component or components will not repair the problem.

In one example embodiment, an improved method and system of detecting lifecycle failures in vehicle functional subsystems, that are caused either by hardware failures or by model errors in requirements, design, or implementation and tracing the failure back to the root cause in the model, is contemplated. For tracing, the method uses a new capability for lifecycle round-trip engineering that links diagnostic agents in the RTE with a dyadic model in the IDE for managing the development and maintenance of vehicle functions and the corresponding diagnostics. The dyadic model in the IDE is managed by linked dyadic tools that develop functions and corresponding diagnostics at each level of the spiral development “V” process (which will be described in more detail later): requirements, design and implementation. The lifecycle diagnostic method, which links the IDE and RTE, can be applied during development, production, and service of the vehicle RTE.

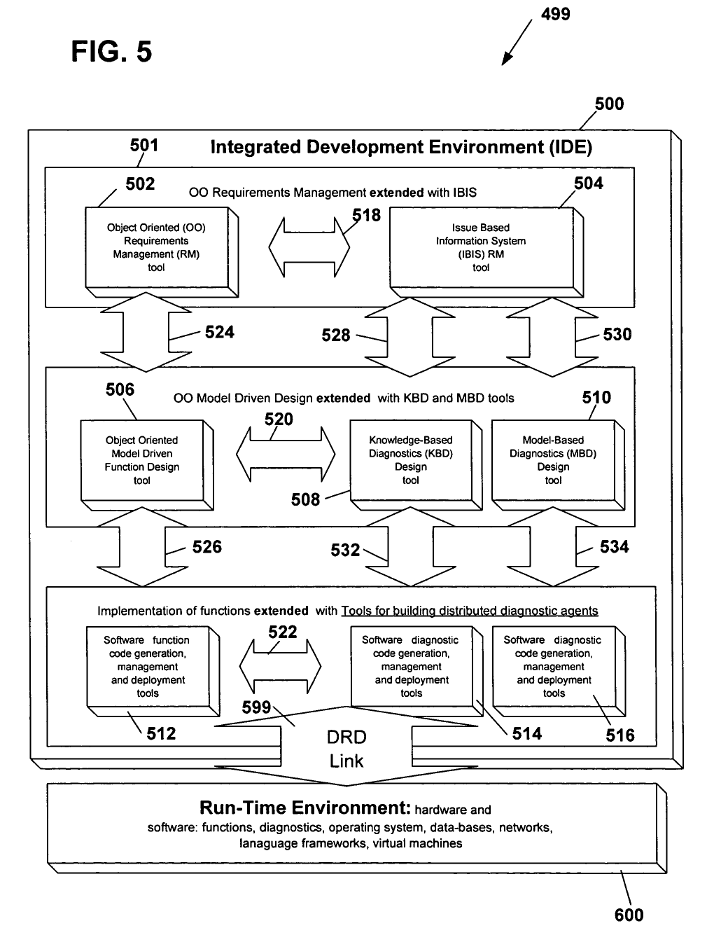

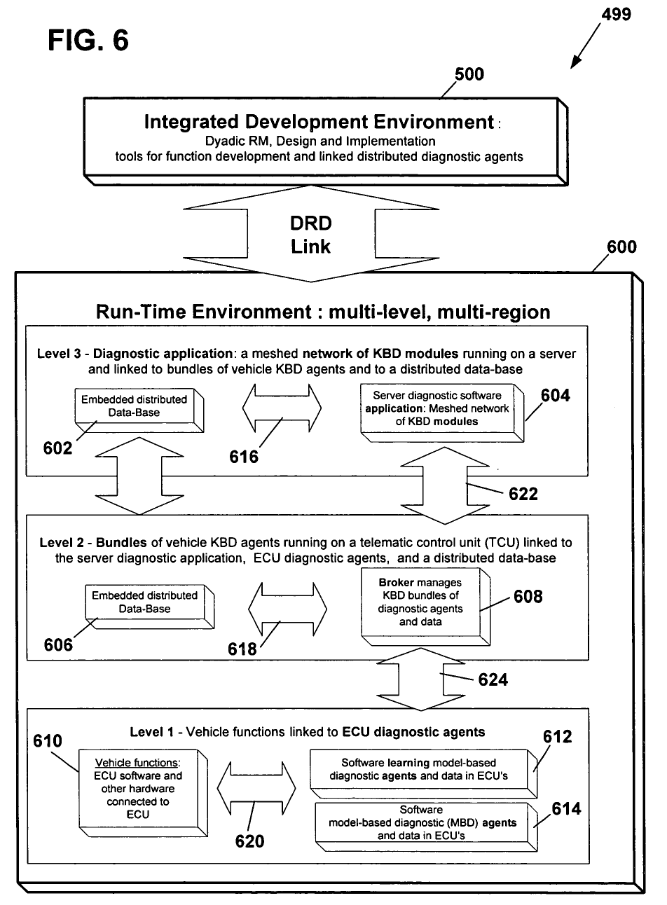

Referring to FIGS. 5 and 6, a learning model-based lifecycle diagnostic system 499 is illustrated. Preferably, the system 499 includes an IDE 500 and a RTE 600 linked by a DRD link 599. FIG. 5 is a system diagram, according to one example embodiment, for a lifecycle diagnostic method for the development of vehicle functions and corresponding diagnostics in the IDE 500 and the deployment of diagnostics in an RTE 600 to service vehicles. The diagram illustrates how the lifecycle method links development tools together in the IDE 500 with linkages. The IDE 500 in the lifecycle method contains development tools and processes to develop vehicle functions and a corresponding diagnostic application consisting of a set of integrated and linked diagnostic agents for deployment in the RTE 600. The IDE 500 and the RTE 600 are linked through a DRD link 599 and corresponding processes. The DRD 599 can include a database, which can be a distributed database.

FIG. 6 is a system diagram, according to one example embodiment, for a lifecycle diagnostic method for the development of diagnostics in an IDE 500 and the deployment of diagnostics in a RTE 600 to service vehicles. The diagram illustrates how the lifecycle method links diagnostic agents together in the RTE 600 with linkages. The RTE 600 in the lifecycle method contains and operates the diagnostic application deployed as a three level system consisting of diagnostic agents, running on servers, TCUs, or equivalent modules that plug into vehicles, and ECU's. Production Service tools interface to the vehicle and are part of the RTE 600. The RTE 600 is linked back to the IDE 500 through the DRD link 599 and corresponding processes.

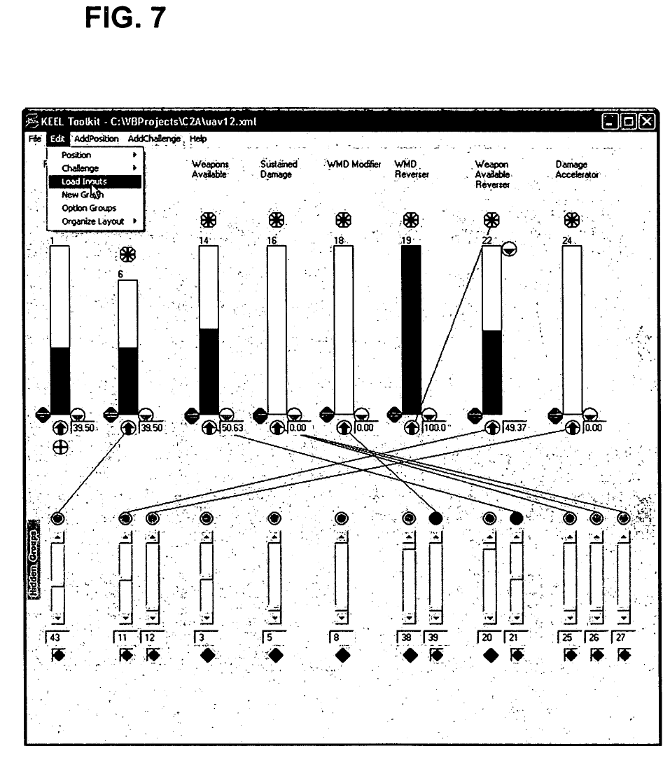

As shown in FIG. 7, an IDE tool such as the Compsim KEEL toolkit can be driven by the data returned in the DRD link 499, FIG. 5, to simulate and test the design model and analyze the failure mode. The data shown below is an example of the input schema defined in XML by the IDE 500, FIG. 5; the schema is stored in the DRD link 599:

- <Schema name=“KEELDataSchemaxml” xmlns=“um:schemas-
microsoft-com:xml-data” xmlns:dt=“um:schemas-microsoft-
com:datatypes”>
<ElementType name=“Index” dt:type=“ui2” />
<ElementType name=“Value” dt:type=“float” />
- <ElementType name=“InDat” content=“eltOnly” model=“closed”>
<element type=“Index” minOccurs=“1” />
<element type=“Value” minOccurs=“1” />
</ElementType>
<ElementType name=“ProjectTitle” content=“textOnly”
model=“closed” dt:type=“string” />
- <ElementType name=“Report” content=“eltOnly” model=“closed”>
<element type=“ProjectTitle” minOccurs=“1” />
<element type=“InDat” minOccurs=“0” maxOccurs=“*” />
</ElementType>
</Schema>

The DRD link 599 eliminates the need for the RTE agents 600 to know how to communicate with the tools in the IDE 500. The system 499 creates the proper linkages between the IDE 500 and the RTE 600 using only the information in the DRD link 599. An example of the data returning from the RTE 600 to the IDE 500 is shown below:

<?xml version=“1.0” ?>

- <Report xmlns=“x-schema:KEELDataSchemaxml.xml”>
<ProjectTitle>UAV1</ProjectTitle>
- <InDat>
<Index>0</Index>
<Value>100</Value>
</InDat>
- <InDat>
<Index>1</Index>
<Value>22</Value>
</InDat>
- <InDat>
<Index>2</Index>
<Value>82</Value>
</InDat>
- <InDat>
<Index>3</Index>
<Value>60</Value>
</InDat>
- <InDat>
<Index>4</Index>
<Value>64</Value>
</InDat>
- <InDat>
</Report>

Referring back to FIG. 5, preferably, the IDE 500 has three levels of development activity for users of the system 499 with corresponding tools and processes. These three levels are requirements management, design, and implementation. The system 499 creates a linked dyadic tool pair for functions and diagnostics at each level in the IDE 500.

At the top of FIG. 5 is the activity called requirements management. Typical model-driven, object-oriented (OO) development tools for requirements management (RM) are IBM/Rational Requisite Pro™ and Telelogic DOORS™. The lifecycle method creates a new dyadic capability for RM by augmenting existing OO RM tools with an issue-based information (IBIS) tool such as the Compsim Management Tool™ (CMT).

The IDE 500 includes a first RM 502, a second RM 504, a first design tool 506, a second design tool 508, a third design tool 510, a first deployment tool 512, a second deployment tool 514, and a third deployment tool 516. Preferably, the first RM 502 is implemented as OO RM Tool, and the second RM 504 is implemented as an IBIS RM Tool. The first design tool 506 is implemented as an OO model-driven function design tool, such as IBM/Rational Rose™, iLogix's Rhapsody™, the MathWorks's Simulink™ or ETAS's ASCET/SD™.

The second design tool 508 is implemented as a knowledge-based diagnostics design tool. The third design tool 510 is implemented as a model-based diagnostics design tool. The second design tool 508 and the third design tool 510 comprise a diagnostic builder tool suite that contains both knowledge-based diagnostic design tools and model-based diagnostic design tools. These tools enable the user of the system 499 to develop run-time diagnostic agents for the corresponding designed vehicle functions. The diagnostic agents are intended to run on the three levels of the RTE 600, FIG. 6. The diagnostic builder suite specifies the targeted level of the RTE 600 for each diagnostic agent and builds the links shown in FIG. 6 between the agents in the RTE 600. An example of a knowledge-based agent development tool is Compsim's KEEL™. An example of a model-based agent development tools is R.O.S.E.'s Rodon™.

The first deployment tool 512 is implemented as a software function code generation, management, and deployment tools such as ASCET/SD™. The second deployment tool 514 is implemented as a software diagnostic code generation, management, and deployment tool. And, the third deployment tool 516 is implemented as a software diagnostic code generation, management, and deployment tool.

The first RM 502 is linked to the second RM 504 via link 518. The link 518 is any standard communication link known in the art. The link 518 is a bi-directional, integrated link that enables capturing the knowledge, assumption, and decision logic behind the requirements captured in the first RM 502. Preferably, the system 499 implements link 518 by passing unique XML function identifier descriptors (FIDs-RM) for objects in the first RM 502 to the second RM 504 and by building a data relationship with XML diagnostic identifier descriptors (DIDs-RM). The dyadic relationship for link 518 is stored in the DRD link 599. By windowing the second RM 504 into the graphic user interface of the first RM 502, the system 499 enables the user to define the decision logic behind the requirement being captured as objects in the first RM 502, such as a use case. The logic in the second RM 504, corresponding to the object in the first RM 502, is defined as unique XML diagnostic identifier descriptors (DIDs).

The first design tool 506 is linked to the second and third design tools 508, 510 via link 520. Link 520 bi-directionally passes unique XML defined function identifier descriptors for design (-D) and diagnostic identifier descriptors for design (-D) and integrates the graphical user interface of the separate tools at the design level.

The first deployment tool 512, or functional module, is linked to the second and third deployment tools 514, 516, or diagnostic agents, via link 522. Link 522 bi-directionally passes unique XML defined function identifier descriptors for implementation (-I) and diagnostic identifier descriptors (-I) and integrates the graphic user interface of the implementation tools. Link 522 is implemented by defining the ECU memory locations and data types for the information corresponding to vehicle modules. ASAM MCD™ with XML is an example of such a link. Tools, such as ETAS's ASCET/SD™ and INCA™, can be used to implement link 522.

The first RM 502 is also linked to the first design tool 506 via link 524. The first design tool 506 is also linked to the first deployment tool 512 via link 526 for implementation. Links 524, 526 enable what is called round-trip engineering for functions in the development environment. Objects corresponding to requirements can be traced through design to the source code in implementation and back up to design and requirements.

Likewise, the second RM tool 504 is linked to the second and third design tools 508, 510 via links 528, 530, respectively. The second and third design tools 508, 510 are linked to the second and third deployment tools 514, 516 via links 532, 534, respectively. Links 532, 534 enable round-trip engineering for diagnostics in the development environment. XML defined design objects for diagnostics are linked to source code for diagnostics.

The system 499 integrates model-based diagnostic design tools, such as R.O.S.E's Rodon™, that generate source code with tools, such as ASCET/SD™, to generate executable code on a real-time operating system for implementation on the RTE 600, FIG. 6.

Referring to FIG. 6, the RTE 600 has three levels of software and hardware. Using the tools in the IDE 500, the DRD Link 599, and processes, the system 499 enables the building of a diagnostic application as a collection of linked diagnostic agents that run on the three levels. Some of the agents can be downloaded onto level 2 using OSGi™.

The RTE 600 includes a first database 602, a server application 604, a second database 606, a broker 608, an electronic control unit (ECU) 610, learning agents 612, and agents 612, 614. Preferably, the first database 602 is an embedded distributed database known in the art. The server application 604 is a server diagnostic software application and meshed network of KBD modules. The second database 606 is an embedded distributed database. The broker 608 manages KBD bundles of diagnostic agents and data. The ECU 610 includes software and other hardware connected to the ECU. The learning agents 612 include software learning model-based diagnostic agents and data in ECU's. The agents 614 include software model-based diagnostic (MBD) agents and data in ECU's.

The first database 602 is linked to the server application 604 via link 616. The second database 606 is linked to the broker 608 via link 618. The ECU 610 is linked to the learning agents 612 and the agents 614 via link 620. The server application 604 is also linked to the broker 608 via link 622. The broker 608 is linked to the learning agents 612 and agents 614 via link 624.

The IDE 500 and RTE 600 are linked via link 599. Link 599 is a Development, Run-time, Development (DRD) link. Preferably, the DRD link 599 is implemented using a telecommunications and operations infrastructure (TOI) containing combinations of a distributed data-base and software interprocess communication (IPC) mechanisms. In the DRD link 599, the information sent through the data-base or IPC mechanisms are defined by XML schemas and contain both IDE 500 and RTE 600 data. The XML schema could be sent in messages or optionally be used to configure a distributed data-base.

During development, new diagnostic tools in the IDE 500 are used to guide users to follow a spiral “V” process “down” and “up” the “V” to build IDE model linkages (as is described in more detail below) between functions uniquely identified with function identifier descriptors (FIDs) and corresponding diagnostics uniquely identified with diagnostic identifier descriptors (DIDs) at the levels of requirements, design, and implementation. The IDE dyadic (function-diagnostic) model linkages with FIDs and DIDs are stored in the DRD link 599 data-base.

Consequently as the method follows the spiral “V” process over iterative prototyping cycles during development, a new dyadic system model is built in the IDE 500 and the DRD link data-base 599. An RTE 600 is also built for the vehicle. The RTE 600 contains a three-tier level of diagnostic agents that are linked together into an integrated diagnostic application architecture (DAA) and linked to the vehicle functions including software with corresponding calibration parameters in ECU's.

The three-tier RTE 600 includes managers on the servers 604 and brokers 608 on the TCUs for dynamically deploying the agents 612, 614 onto vehicles such as downloading agents to a vehicle's TCU or a vehicle service module (VSM).

In the RTE 600, run-time linkages or run-time binding between software objects is performed by the agent manager and brokers using the IDE defined XML schemas and data such as the FIDs and DIDs contained in the DRD link 599. This enables linking agents together and linking agents with functions.

An example of the linking is connecting a diagnostic agent with a calibration parameter in an engine ECU. In an IDE 500 using UML, these connections might also include ports and protocols. In an IDE 500 and a RTE 600 complying with the Association for Standardization of Automation and Measurement (ASAM), additional access methods for measurement, calibration and diagnosis (MCD) that relate to ECU's in vehicles would be defined. These access methods would still be contained in the DRD link 599 and represented as XML schemas with embedded data.

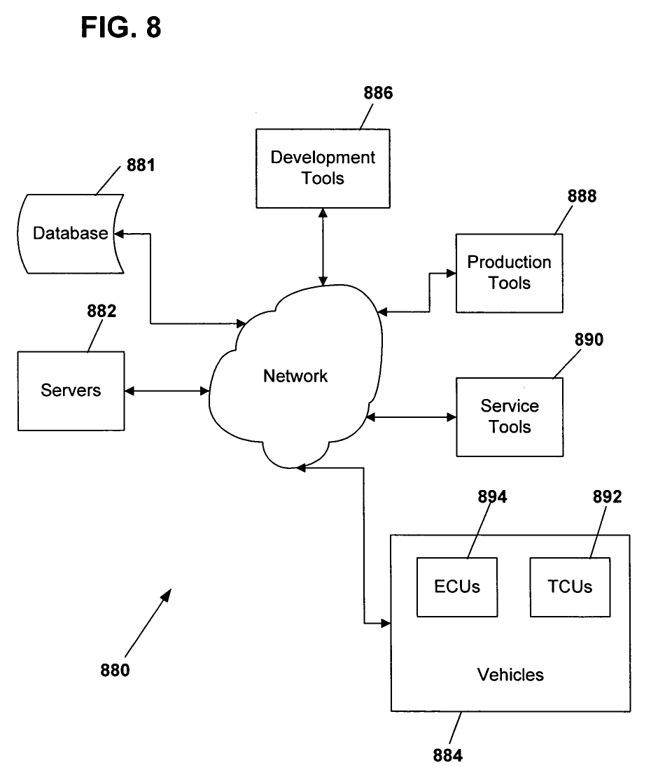

Referring to FIG. 8, a lifecycle diagnostic method manages vehicles in a distributed system 880. The distributed system include a database, 881, servers 882, vehicles 884, tools for development, production and service, 886, 888, 890 and modules inside the vehicle such as TCUs 892 and ECUs 894. Preferably, the architecture that the method uses to define the system is the ISO Open System Interconnection (OSI) seven layer reference model. The layers are application, presentation, session, transport, network, data link, and physical. The DAA comprises the top three layers of the seven layer “stack” for a node, and the TOI comprises the bottom four layers of the stack.

Root cause tracing occurs with lifecycle round-trip engineering that links the detected failures in the vehicle RTE 600, FIG. 6, with the elements of the model in the IDE 500, FIG. 5. The linkage is implemented by using the IDE 500 linkages stored in the data-base. By tracing the linkages built with tools in an IDE 500, the candidates for root cause in requirements, design, and implementation can be determined.

A spiral lifecycle process is triggered by the likely detection of failures by cooperative, autonomous diagnostic agents in the vehicle RTE 600, FIG. 6. The agents would apply a range of algorithms and technologies that can be classified in several categories: model-based diagnostics (MBD), learning model-based diagnostics (LMBD) or knowledge based diagnostics (KBD). Current OBD diagnostic agents use MBD that frequently applies exponential moving averages, which are first order Kalman filters, to design acceptable Type 1 and Type 2 statistical error profiles.

The trigger can be assisted by service tools connected to the vehicle RTE 600. FIG. 6. The trigger sends information through messages or a distributed data-base to the vehicle's diagnostic application running on one or more servers. The messages or data-base transactions from the vehicle to the server(s) are created by the vehicle's TCU after being fed information from a combination of MBD and LMBD agents running in ECU's and a combination of MBD, LMBD, and KBD agents running in the TCU.

LMBD agents can apply time-frequency based performance assessment technology to avoid using a model (with errors) for filtering and detection of a signal as a failure. Time-frequency analysis (TFA) provides a method for managing a combined time-frequency representation of a signal or a set of signals that represent the normal behavior of a system. The behavior can vary over time and frequency. TFA is a method for detecting both slow degradation and abrupt failures. Newly developed TFA methods can identify the behavior of a system's signature in ways that are difficult or impossible using time-series or spectral analysis. Optimal design methods for TFA include the Reduced Interference Distribution or RID. RID optimization achieves the goal of providing high resolution time-frequency representations. Learning MBD agents built with RID TFA technology exhibit many desirable properties such as very rapid identification of failures without using a model, with minimal processing and with engineered statistical confidence in the detection.

Referring back to FIGS. 5 and 6, preferably, a learning model-based lifecycle diagnostics system 499 includes an IDE 500, linkages within the IDE between IDE tools, an RTE 600, linkages within the RTE 600, and a DRD link 599. These linkages, operating with agents and tools in the RTE 600 and tools in the IDE 500, enable the system to trace failures, or anomalies, detected in the RTE back to the root cause as model errors in the IDE.

To trace model failures back from the RTE 600 to the IDE 500, the method implements round-trip engineering between diagnostic agents in the RTE 600 and diagnostics linked to the corresponding vehicle functions in the IDE 500. The functions are represented as a model with objects. Because the agents, processes, tools, and linkages operate together in a spiral process to learn model errors over a vehicle's lifecycle, the method is called lifecycle learning-model based diagnostics.

An IDE 500 is an integral part of the lifecycle method in addition to a RTE 600 for software on the vehicle and software that supports the production and service of the vehicle. Service of the vehicle includes service operations at dealers and a telematic service such as OnStamm. Preferably, the RTE 600 includes fleets of vehicles, the electronic control units (ECU's), networks, sensors, actuators and user interface devices such as speedometers on dashboards on individual vehicles, and a telecommunications and operations infrastructure (TOI) that includes computers such as distributed servers, communication networks such as cellular and wireless LAN's such as WIFI, and tools such as diagnostic scan tools generally found at OEM dealerships and independent aftermarket (IAM) repair shops.

Preferably, the IDE 500 is a computing laboratory and experimental driving environment with a collection of development tools for developing and maintaining vehicle functions such as power train electronics, including the ECU's, sensors, and actuators for an engine and transmission, body electronics, such as the ECU's, sensors, and actuators for lighting systems, and chassis electronics, such as the ECU's, sensors, and actuators for anti-lock braking systems (ABS). The vehicle functions are implemented in systems such as power train and corresponding subsystems, such as engine cooling. These systems and subsystems include both hardware and software. The IDE 500 is also used to develop the enterprise application software (alternately called the information technology or IT software) to support vehicle production and service operations.

The software that implements vehicle functions generally runs on electronic control units (ECU's) and an optional telematic control unit (TCU) residing on the vehicle. The application software runs on computers such as servers and PC's and for service tools such as diagnostic scan tools. The development of vehicle diagnostic software for service operations is commonly called authoring. The diagnostic software on the vehicle is called on-board diagnostics (OBD).

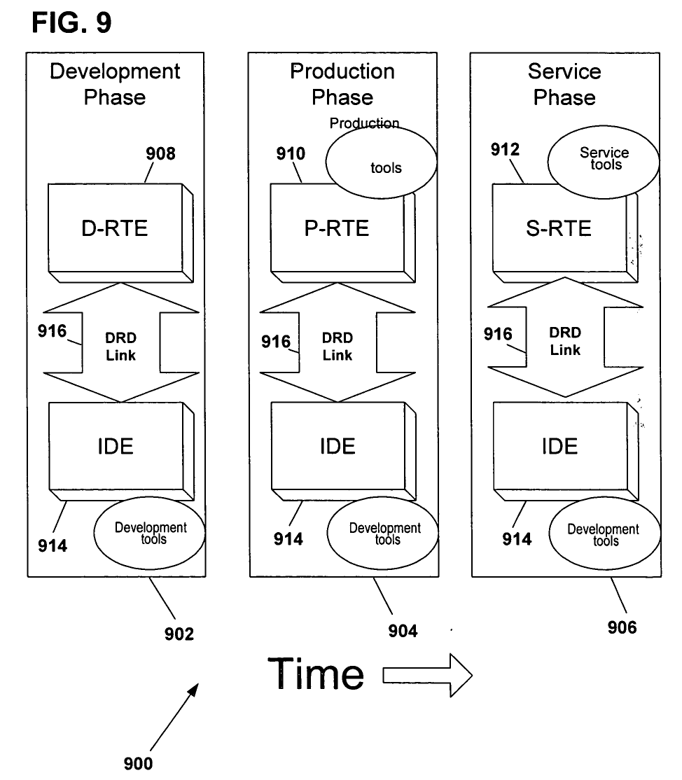

The processes used in the methods of the IDE 500, FIG. 5, are illustrated in FIGS. 9-18. As these processes are followed, the linked tools in the IDE 500 build information in the DRD 599 to link the diagnostic application and agents in the RTE 600 with the IDE 500. Those agents read the DRD 599 to find FIDs linked with DIDs.

FIG. 9 is a process diagram illustrating a vehicle product development lifecycle 900, according to an exemplary embodiment of the present disclosure. The product development process for a specific model year of a vehicle over its lifecycle is conceptually divided into three phases including a development phase 902, a production phase 904, and a service phase 906. Development, production and service activities require the management of large amounts of software. Software creates a major part of the vehicle function and a major part of a business information system to support the vehicle's lifecycle.

Development of a production and service capability including the tools for production and service occurs during the development phase 902. Capability is defined as people with knowledge, tools, technology, and processes. There is an associated architecture that represents the structure of the capability, including a business information system, represented by tools and technology. There is a large amount of software in the business system. The associated architecture also includes the structure of the vehicle, including its subsystems, that include its on-board information system. There is also a board diagnostic (OBD) system in the vehicle. This OBD system includes a large amount of software. Part of the OBD system is required by government regulations to indirectly monitor the vehicle's emissions by monitoring the operation of the vehicle's emission control systems. Typically, there is almost as much diagnostic software in a vehicle's power train ECUs as there is control software.

The information system on the vehicle typically includes many electronic control units (ECUs). Vehicles typically have fifty or more ECUs. These ECUs contain a large amount of software. The architecture of a vehicle, and its production and service systems, are completely defined during development. The development phase 902 typically begins with a large part of the architecture previously determined in a research and development (R&D) phase (not shown) that precedes the development phase 902. The architectural model for a vehicle model is typically derived from a platform model, which includes power train, chassis body, and other subsystem components.

The product development process enables development, production, and service of both the vehicle and the business system as a product. The process operates with the corresponding business system that supports the vehicle during development, production, and service.

The product and the business system are supported by the process, which is part of an organizational capability. The capability has an associated architecture. The architecture relates to both the vehicle and the business system. The capability includes internal and external (outsourced) services with people and their knowledge, applications, tools, platforms, components, and technology. The capability supports the vehicle as a product and the business system in the supply and service chains. These chains support the original equipment manufacturer (OEM) and the vehicle as a product over the lifecycle.

The lifecycle for a vehicle typically lasts more than ten years. The development phase 902 is about two to three years, followed by several years of the production phase 904 for several model years. The production phase 904 is followed by many years of the service phase 906. The initial part of the service phase 906 for a specific vehicle typically includes an original equipment service (OES) warranty period of three or more years that is followed by a service period that includes the independent aftermarket (IAM).

These development, production, and service phases 902, 904, 906 are illustrated as following each other sequentially over time, but there is overlap that will be illustrated in subsequent figures. The production phase 904 begins with the start of production (SOP). The service phase 906 begins with the first customer shipment (FCS) of a vehicle. As many vehicles are produced for a model year, the production and service phases 904, 906 overlap.

In each phase 902, 904, 906 of the process, there is an RTE and an IDE. The RTE is specific to a phase. D-RTE 908 represents a development-RTE; P-RTE 910 represents a production RTE; and S-RTE 912 represents a service RTE. A manufacturing plant with production tools would be included in the P-RTE 910. An OEM dealer's service department with service tools would be included in the S-RTE 912. A single IDE 914 with development tools is common to all phases and linked to each specific RTE 908, 910, 912. The IDE 914 would typically be applied in the supply and service chains, and in the OEM and its business partners. The specific RTEs 908, 910, 912 are connected to the IDE 914 through a DRD Link 916.

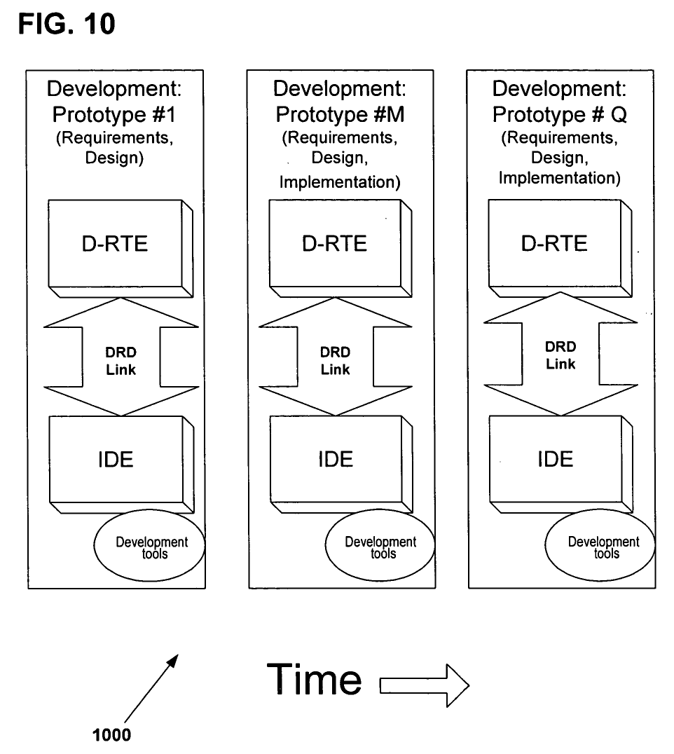

FIG. 10 is a process diagram illustrating the spiral lifecycle process 1000 used during the development phase 902, FIG. 9, of the lifecycle to produce prototype cycles, according to an exemplary embodiment of the present disclosure.

The development phase 902, FIG. 9, of the product development process is used to develop prototypes with a spiral sub process 1000. The sub process 800 fits inside the development phase 902. The vehicle model, and its supporting business system to be developed, consists of components in the categories of requirements, design, and implementation. Development typically begins with an activity to determine and specify some parts of the requirements model for the vehicle and its supporting business system, and then development proceeds to determine and specify some part of the design model for the vehicle and its supporting business system, which includes the RTE with its development, production, and service tools.

Development tools typically support simulation of design models, which enable testing to occur without fully implemented vehicles and supporting systems. Development tools with simulation and testing capabilities such as hardware in the loop (HIL) or software in the loop (SIL) are used to permit incremental development of subsystems before a completed vehicle is available. As development proceeds, some part of an implementation model can be determined and specified. The spiral process is used to incrementally complete parts of requirements, design, and implementation. The spiral process permits repeated forward sequences such as implementation determination and specification that follows design or reverse sequences such as requirements development that follow either design or implementation. Modern software engineering and corresponding tools encourages use of a spiral process during development to speed development, improve quality, and lower development cost.

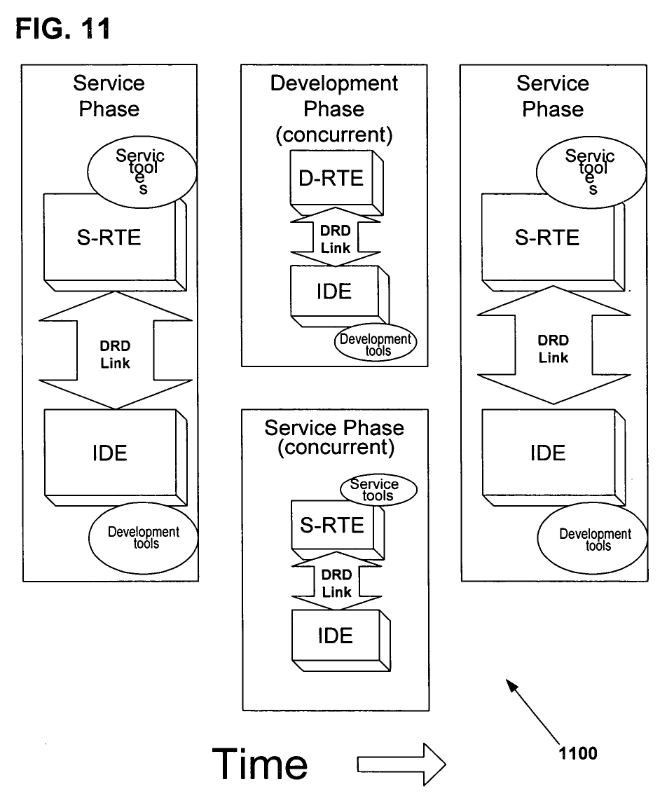

FIG. 11 is a process diagram illustrating the spiral lifecycle process 1100, with periods of concurrent development and service operations, according to an exemplary embodiment of the present disclosure.

The Lifecycle Spiral Process 1100 is required because during the service phase of the vehicle's lifecycle, faults and anomalies will be encountered. Faults are failures that have been previously analyzed and are predicted from a failure mode model. A procedure for determining root cause is probably known and can be effectively applied. Faults can typically be corrected in the field by repair procedures that include swapping or replacing parts.

Anomalies are failures that have not been previously analyzed and are not predicted from a failure mode model. A large part of the anomalies will have root causes in model errors, such as software bugs. Model errors will be found in the implementation of the vehicle and/or its supporting business system. The correction of these errors must be performed by returning to a development phase. The development phase operates concurrently with service operations as shown.

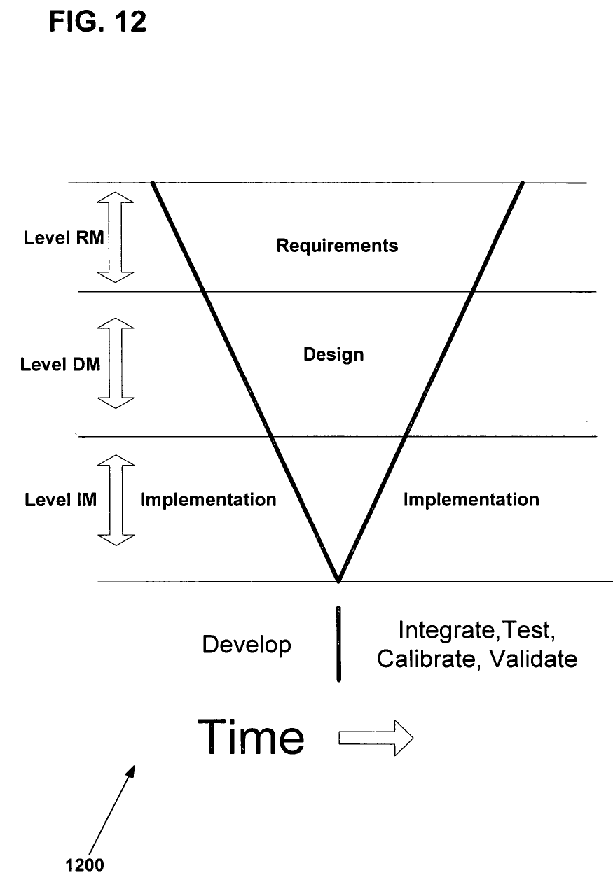

FIG. 12 is a process diagram illustrating the vehicle development phase containing prototype cycles 1200 as conceptual “V” cycles, according to an exemplary embodiment of the present disclosure.

The Development Phase 902, FIG. 9, includes prototype cycles 1200 that follow the shape of a “V”. The “V” begins with the development of some parts of a vehicle model and business system as requirements, then optionally proceeds to development of parts of the design model and then optionally to development of parts of the implementation model. At the bottom of the “V”, the focus of development activity then shifts to integration, testing, calibration, and validation of the parts of the model that have been developed.

The “down cycle” is on the left and the “up cycle” is on the right side of the diagram. Horizontally across the “V” is a corresponding part of the model to be integrated, tested, calibrated, or validated. After being partially developed, components of requirements can be integrated, tested, and validated through methods like simulation. An early prototype “V” cycle might only include development and testing of requirements. After some parts of the design or implementation model have been developed, that part of the model can be integrated, tested, and validated with the previous parts of the model for the vehicle and business system. Each prototype cycle develops, integrates, tests, and validates more parts of the model, with components that include requirements, design, and implementation.

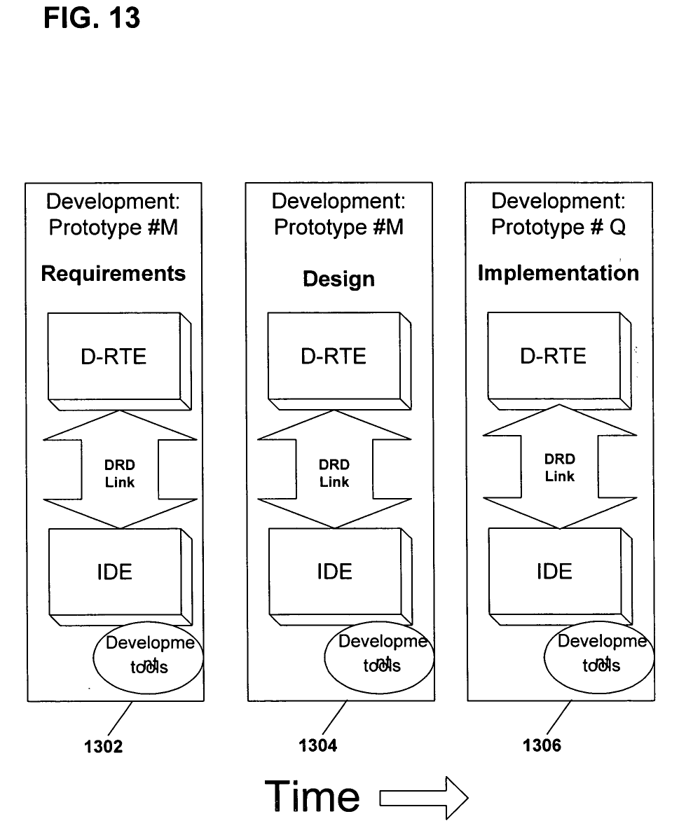

FIG. 13 is a process diagram illustrating how the lifecycle method progresses using the spiral process through requirements, design, and implementation, according to an exemplary embodiment of the present disclosure.

The development phase 902, FIG. 9, progresses through prototyping cycles 1302, 1304, 1306. Each cycle initially moves through a “down cycle” of the “V” cycle that includes the development of the model in terms of the attributes of requirements, then design, and finally implementation. Early “down cycles” need only develop requirements before entering an “up cycle” to begin testing and validating the requirements. Most prototyping cycles in the development phase will include the development of the model in terms of the attributes of requirements, design, and implementation in the “down cycle”.

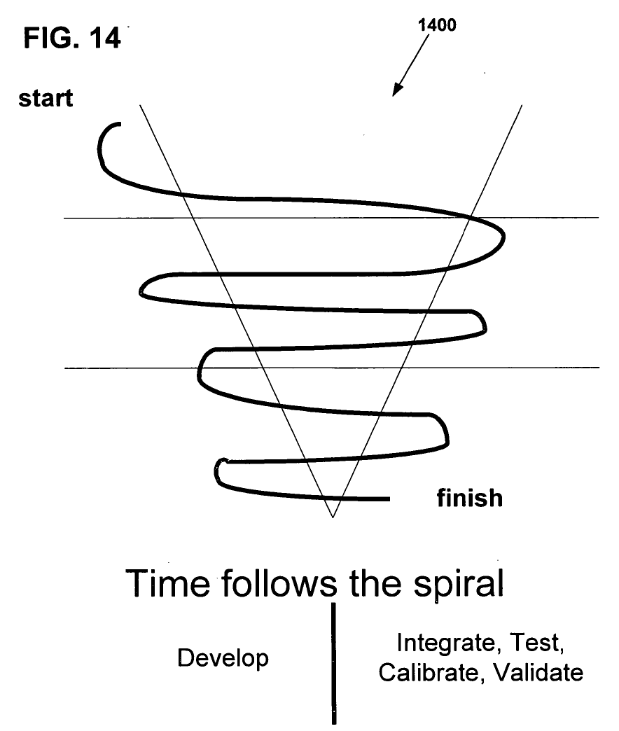

FIG. 14 is a process diagram illustrating how the lifecycle method applies a spiral sub process, according to an exemplary embodiment of the present disclosure.

The development phase 902, FIG. 9, includes prototype cycles 1400. The cycles 1400 use a spiral process to move through the “V” initially in a “down cycle” as illustrated. With the spiral process, parts of the requirements attributes of the prototype model are developed and then tested, followed by parts of the design being developed and then tested, and then parts of the implementation attributes are developed and then tested.

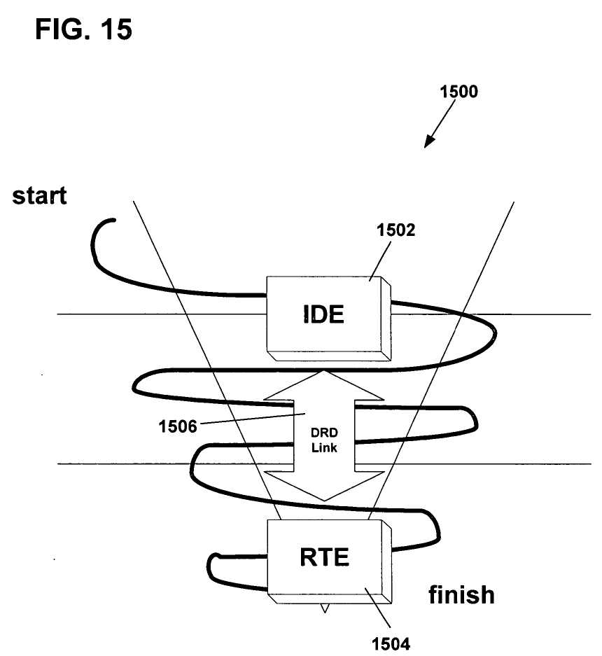

FIG. 15 is a process diagram illustrating how the lifecycle method is applied with a linked IDE and RTE, according to an exemplary embodiment of the present disclosure.

The development phase 902, FIG. 9, has prototype cycles 1500 and uses a spiral process to move through the “V”. In developing parts of the model, an IDE 1502 is required. In testing, calibrating, and validating parts of the implementation model, a RTE 1504 is required. To effectively move along the spiral process, the IDE 1502 and RTE 1504 should be linked via a DRD link 1506. The IDE 1502 is mainly applied on the top and middle of the “V”, and the RTE 1304 is applied on the bottom of the “V”. The spiral process that moves through the “V” is enabled by the linked IDE 1502 and RTE 1504. The linkage is required during “down cycles” and “up cycles”. In the “down cycle” the information flow is mainly from the IDE 1502 to the RTE 1504 because the focus is on ending with an implementation as a RTE 1504.

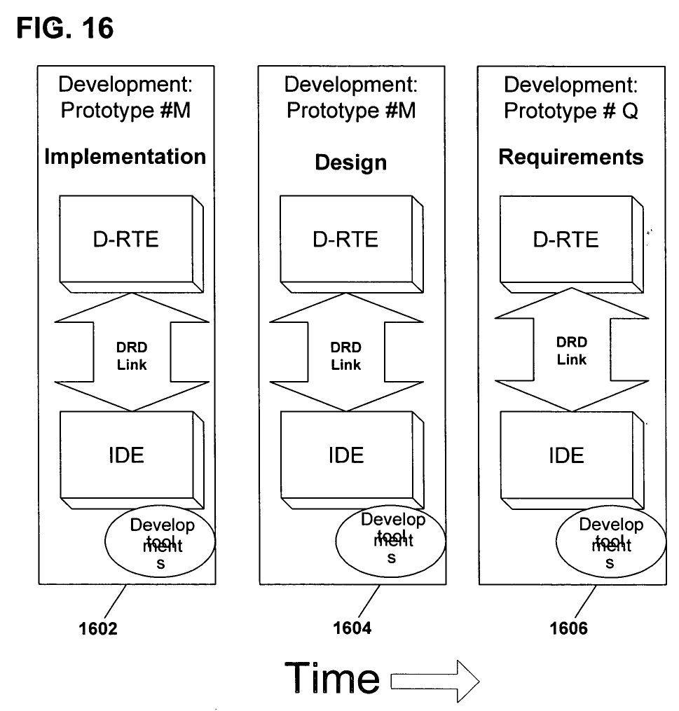

FIG. 16 is a process diagram illustrating how the lifecycle method progresses, according to an exemplary embodiment of the present disclosure.

The development phase 902, FIG. 9, progresses through prototyping cycles 1602, 1604, 1606. Each cycle eventually moves through an “up cycle” in the “V” that includes the integration, testing, calibration, and validation of the model in terms of the attributes of implementation, then design, and finally requirements. Early “up cycles” involve only requirements. Later “up cycles' involve requirements and design. Most prototyping cycles in the development phase will include the development of the model in terms of the attributes of requirements, design, and implementation in the “down cycle” followed by the integration, testing, calibration, and validation of the implementation, design, and requirements in an “up cycle”.

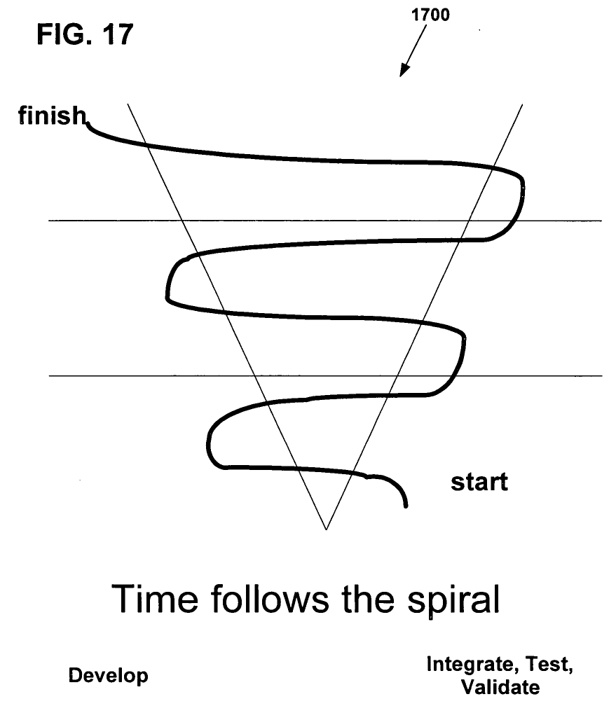

FIG. 17 is a process diagram illustrating how the lifecycle method applies a spiral sub process, according to an exemplary embodiment of the present disclosure.

The development phase 902, FIG. 9, includes prototype cycles. The cycles use a spiral process 1700 to move through the “V” initially in a “down cycle” and then in an “up cycle” as illustrated. With the spiral process, parts of the implementation attributes of the prototype model are integrated and then tested, followed by parts of the design being developed and then tested, and then parts of the requirements attributes are then tested and validated.

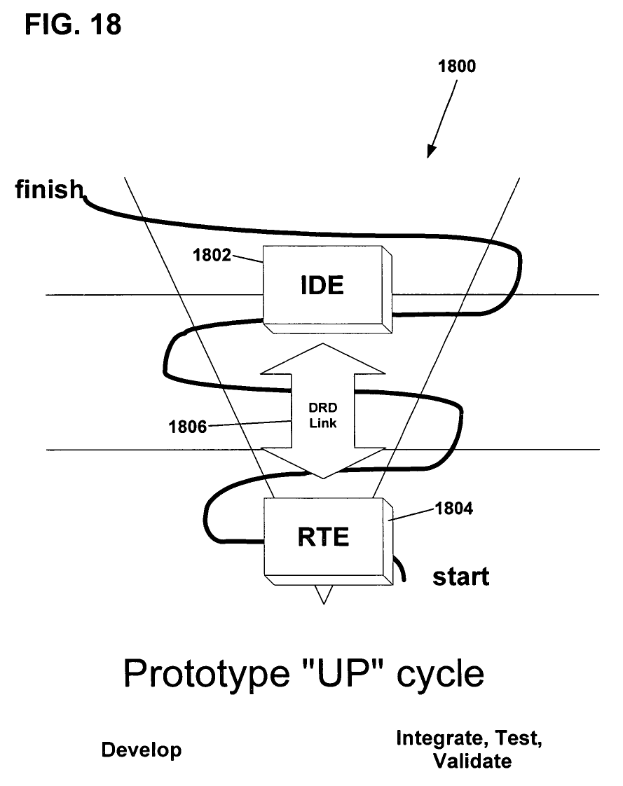

FIG. 18 is a process diagram illustrating how the lifecycle method is applied in the spiral sub process, according to an exemplary embodiment of the present disclosure.

The development phase 902, FIG. 9, has prototype cycles and uses a spiral process 1800 to move through the “V”. In developing parts of the model, an IDE 1802 is required. In testing, calibrating, and validating parts of the implementation model, a RTE 1804 is required. To effectively move along the spiral process, the IDE 1802 and RTE 1804 should be linked via a DRD link 1806. The IDE 1802 is mainly applied on the top and middle of the “V”, and the RTE 1804 is applied on the bottom of the “V”. The spiral process 1800 that moves through the “V” is enabled by the linked the IDE 1802 and the RTE 1804. The linkage is required during “down cycles” and “up cycles”. In the “up cycle”, the information flow is mainly from the RTE 1804 to the IDE 1802 because the focus is on ending with a validated model with a set of requirements and a design in the IDE.

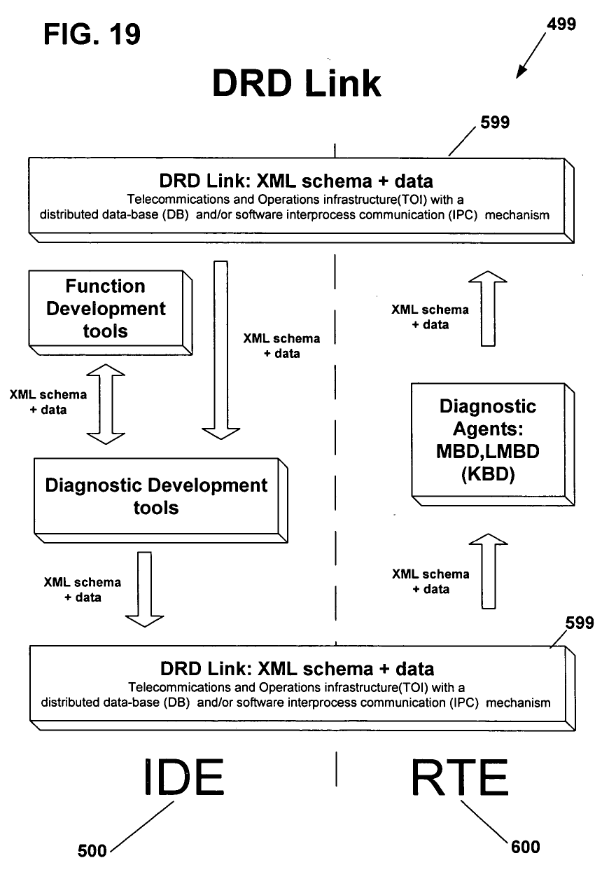

As shown in FIG. 19, a diagnostic agent, built with a specific DID-I that it reads as internal data, can detect a failure in a corresponding function's module in the RTE 600. The agent then accesses the DRD 599 to find the FID-I linkage to write information into the DRD 599 that can be read by any of the tools in the IDE 500 or by additional agents in the RTE 600. If the agent is in an ECU and the ECU has no direct access to the DRD 599, the agent sends a message to an agent in the TCU, which does have access to the DRD 599.

Once linked to the IDE 500, round-trip engineering of the diagnostics to functions is enabled using the linkages inside the IDE 500 guided by the information created in the DRD 599 by the RTE 600.

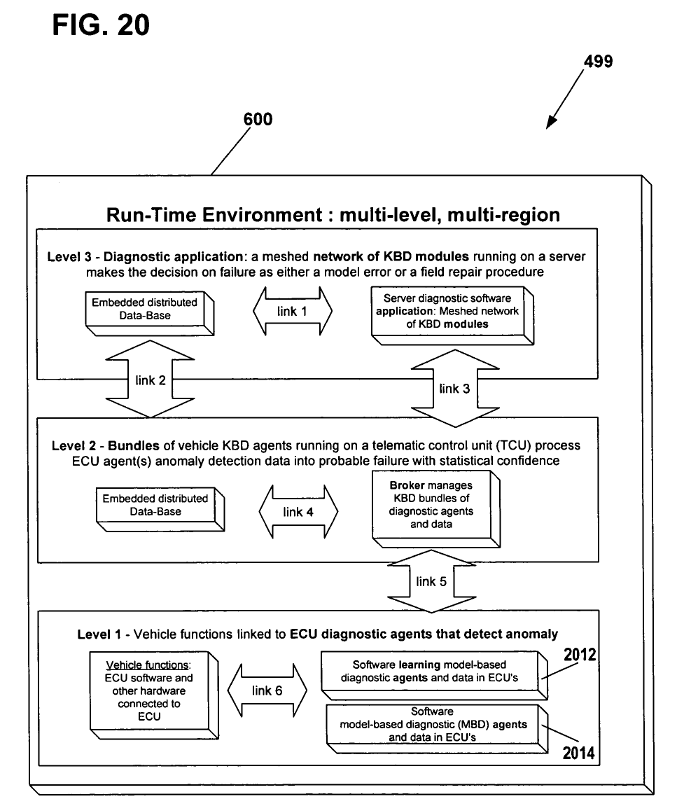

As shown in FIG. 20, the system 499 uses first and second agents 2012, 2014 to detect failures, faults, or anomalies. The second agent 2014 is a model-based diagnostic (MBD) agent that can use model and iterative procedures to determine a root cause for known failure modes. Examples of such agents are the MBD agents built using a tool, such as R.O.S.E. Rodon™. These MBD agents are not effective with new failures that were not anticipated in the model. To compensate for that gap in detection capability, the system 499 creates and applies the first agent 2012, or a learning model-based diagnostic (LMBD) agent, using embedded data mining algorithms, such as time-frequency analysis (TFA), that learn a model by observing an operating vehicle. These algorithms are trained and calibrated during specific normal operating times and then placed in a watch mode at run-time in the vehicle RTE 600.

In the system 499, the LMBD agents 2012 detect a superset of the failures detected by the MBD agents 2014. The LMBD failures can be classified as either (1) a previously anticipated failure that can be fixed in the field, or (2) a new failure that can be either a model error or another new type of hardware failure. The classification occurs by comparing the output of the MBD agents 2014 with the LMBD agents 2012. If the MBD agents 2014 have seen the failure mode before with a statistical confidence factor, then the failure is probably not a model error. If the MBD agents 2014 have a low confidence factor indicating a new failure mode not previously seen, then a model error needs to be investigated and the service technician is told not to swap a part in the field.

An investigation occurs as the RTE agents write information into the DRD link 599, FIG. 6, which enables the IDE 500, FIG. 5, to trace the failures back to the levels of the model represented at the levels of implementation, design and requirements. The system 499 identifies which functions are linked to the failure. A simulation can be run in the IDE 500, FIG. 5, to duplicate the failure mode. The simulation assists in the determination of the root cause. Thus, the LMBD agents 2012 can detect anomalies.

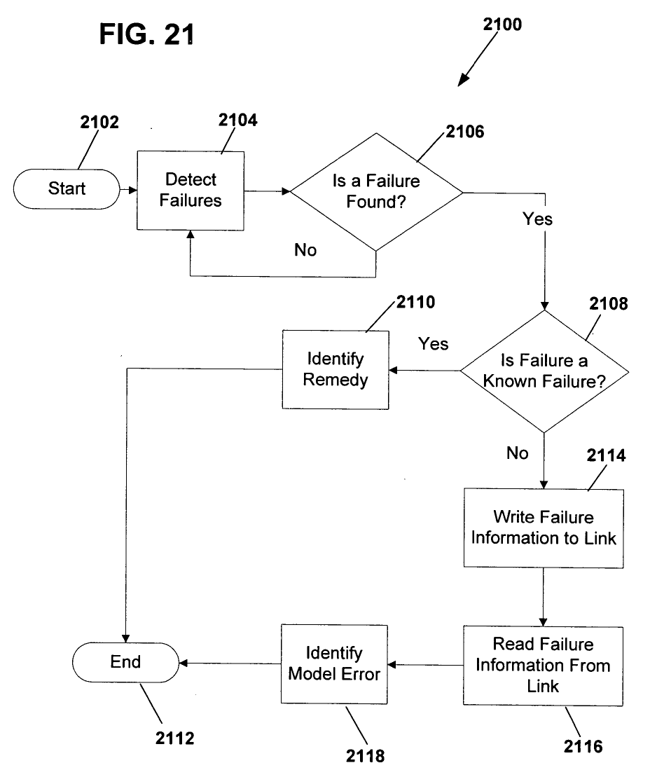

FIG. 21 is a flow chart representing logical operations of a learning model-based diagnostic system 2100. Entrance to the operational flow of the learning model-based diagnostic system 2100 begins at a flow connection 2102. A detect operation 2104 detects a failure. It is noted that diagnostic agents, such as those previously described herein, continuously monitor a vehicle's functions. Such agents are generally located within the RTE, such as RTE 600 of FIG. 6, operating on a vehicle. A found module 2106 determines if a failure has been found. If the found module 2106 determines that a failure has not been found, operational flow branches “No” to the detect operation 2104. In this manner, the vehicle is continuously monitored.

If the found module 2106 determines that a failure has been found, operational flow branches “Yes” to a known module 2108. The known module 2108 determines if the failure is a known failure. If the known module 2108 determines that the failure is a known failure, operational flow branches “Yes” to an identify operation 2110. The identify operation 2110 identifies the remedy for the known failure. Operational flow ends at termination point 2112.

If the known module 2108 determines that the failure is not a known failure, operational flow branches “No” to a write operation 2114. The write operation 2114 writes the failure information to a link, such as the DRD link 599 of FIG. 6. A read operation 2116 reads the failure information from the link. The failure is read into the IDE, such as IDE 500 of FIG. 5. A model operation 2118 identifies the model error, which may be an error is the requirements, design, or implementation level of the IDE. Operational flow ends at termination point 2112.

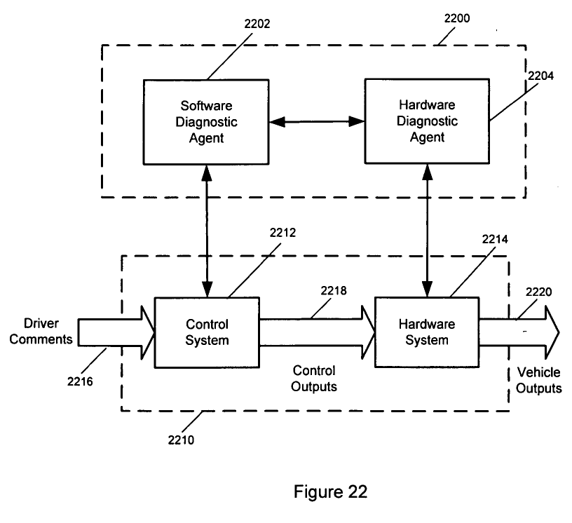

FIG. 22 is a block diagram illustrating a diagnostic layer 2200 that includes software diagnostic agents 2202 and hardware diagnostic agents 2204, for example, the LMBD agents 2012 of FIG. 20. The diagnostic layer 2200 can run in an RTE, for example, the RTE 600 of FIG. 20. The diagnostic layer 2200 monitors a vehicle system 2210. The vehicle system 2210 includes a control system 2212 and a hardware system 2214. The control system 2212 receives driver inputs 2216 and provides control inputs 2218 to the hardware system 2214. The hardware system 2214 provides vehicle outputs 2220 to operate the vehicle.

The software diagnostic agents 2202 monitor the control system 2212. Likewise, the hardware diagnostic agents 2204 monitor the hardware system 2214. Preferably, the diagnostic agents 2202, 2204 detect anomalies in accordance with an anomaly detection scheme based on regionalization using self-organizing maps and time frequency analysis. Of course, other suitable methods can be used.

Self-Organizing Maps (SOM) define a nonparametric regression solution to a class of vector quantization problems. This nonparametric regression method involves fitting a number of ordered discrete reference vectors to the probability distributions of input vectorial samples. SOM is similar to a Vector Quantization (VQ) technique, which is a classical data compression method that usually forms an approximation to the probability density function p(x) of stochastic vectors xε [symbol] ⁿ, using a finite number of code vectors or code words mᵢε [symbol] ⁿ, i=1,2, . . . , k. For each codeword mᵢ, a Voronoi set can be defined as follows,
Vᵢ={xεⁿ|d(x,mᵢ)≦d(x,mⱼ),∀j≠i}
that contains all the vectors that are the nearest neighbors to the corresponding code vector mᵢ. The d(•,•) is a distance measure defined on the linear vector space [symbol] ⁿ, and could be, for example, the well-known Euclidean distance. All the Voronoi sets construct a partition of the entire vector space [symbol] ⁿ. Therefore, once the codebook is determined according to some optimization criterion, then for any input vector x, it can be encoded into a scalar number, which is an index c whose associated code vector is closest to x in the sense that the distance measure d(•,•) yields the minimum value, i.e.

$$c = arg {min}_{i} \{ d ( x , {m}_{i} ) \}$$

The optimal selection of the codewords mᵢε [symbol] ⁿ,i=1,2, . . . ,k shall minimize the average expected quantization error function:
E=∫f(d(x,m_{c}))p(x)dx
where f (•) is some monotonically increasing function of the distance measure d(•,•). It is noted that the index c is a function of input vector x and all the code vectors Mᵢε [symbol] ⁿ,i=1,2, . . . , k. It can be easily observed that c can change discontinuously. As a result, the gradient of expected quantization error E with respect to mᵢε [symbol] ⁿ,i=1,2, . . . ,k is not continuously differentiable. Since the close form solutions for mᵢε [symbol] ⁿ,i=1,2, . . . ,k that minimize are generally not available, one has to iteratively approximate the optimal solutions. It has been shown, in a particular case, when f (d(x,m_{c}))=∥x−m_{c}∥², the steepest descent can be obtained in the direction of −∇ₘ_{ⱼ}E|ₜ=2·δ_{cj}·(x(t)−mⱼ(t)) at iteration step t, where δ_{cj} is the Kronecker delta function. If one defines the step size by the learning rate factor α(t) that includes the constant −2 from the gradient ∇ₘ_{ⱼ}E|ₜ=−2·δ_{cj}·(x(t)−mⱼ(t)), then one arrives at an updating formula:
mᵢ(t+1)=mᵢ(t)+α(t)·δ_{ci}·(x(t)−mᵢ(t))

The set of vectors mᵢε [symbol] ⁿ,i=1,2, . . . , k obtained, which minimize the average expected quantization error E, can map the space of input vectors into a set of finite codebook reference vectors. However, the indexing of those reference vectors can be arranged in an arbitrary way, i.e. the mapping is still unordered. The reason is, for any input vector x, it can only affect the code vector that is nearest to it because of the delta function δ_{cj} used.

Unlike the VQ technique, SOM is able to map high dimensional data onto a much lower dimensional grid, while preserving the most important topological and metric relationships of the original data elements. This kind of regularity of the neighboring reference vectors is coming from their local interactions, i.e. the reference vectors of adjacent nodes in the low dimensional grid up to a certain geometric distance will activate each other to learn something from the same input vector xε [symbol] ⁿ. This results in a local smoothing effect on the reference vectors of the nodes within the same neighborhood and leads to global ordering. Due to this order property, the map tends to reveal the natural clusters inherent to input vector space and their relationships.

The SOM can be interpreted as a nonlinear projection of a high-dimension sample vector space onto a virtually one or two dimension array that is represented by a set of self-organized nodes. Each node is associated with a reference vector that has the same dimension as the input vector. The distance measure used in this report is the well-known Euclidean distance. The Best Matching Unit (BMU) for an arbitrary input vector xε [symbol] ⁿ is defined as

$$c = arg {min}_{i} \{ ‖ x - {m}_{i} ‖ \}$$

In simple terms, the reference vector associated with the BMU yields the minimum Euclidean distance with respect to the input vector x. To ensure the global ordering of the SOM during learning process, one has to expand the influence region of the input vector, instead of only updating the reference vector of the BMU. One alternative is to replace the delta function δ_{cj} with a new neighborhood function h_{ci}(t) that depends on time t and the distance between two nodes c and i on the two dimensional grid. This gives the following formula for the reference vectors:
mᵢ(t+1)=mᵢ(t)+h_{ci}(∥r_{c}−rᵢ∥,t)·(x(t)−mᵢ(t))
where t=0,1, . . . is the discrete time index and r_{c}, rᵢε [symbol] ² are locations of nodes c and i in the grid.

For convergence of the network, it is necessary that as h_{ci}(∥r_{c}−rᵢ∥, t)→0 when t→∞. In addition, the degree of the “elasticity” of the network is related to the average width or sharpness of the neighborhood function h_{ci}(∥r_{c}−rᵢ∥,t), where h_{ci}→0 with increasing ∥r_{c}−rᵢ∥. The simplest but effective choice for h_{cj}(t) is

$${h}_{ci} ( t ) = \{ \begin{matrix}α ( t ) , ∀ i ∈ {N}_{c} ( t ) \\ 0 , otherwise\end{matrix}$$

where N_{c}(t) is neighborhood set with a specified radius around node c in the two dimension grid and α(t) is a small scalar number between 0 and 1. α(t) and the radius of N_{c}(t) are monotonically decreasing functions of time. Another common choice for the neighborhood function h_{ci}(t) is

$${h}_{ci} ( t ) = α ( t ) \cdot exp ( - \frac{{‖ {r}_{c} - {r}_{i} ‖}^{2}}{2 {σ}^{2} ( t )} )$$

where α(t) is the learning rate factor and σ(t) defines the width of the h_{ci}(t). They are both monotonically decreasing functions of time.

For small sized SOMs, the choice of those parameters is not important, for example, a few hundred nodes. However, for very large SOM, those parameters have to be chosen carefully to ensure convergence and global ordering of the reference vectors. The computation steps of the algorithm can be summarized as follows:

1. Choose the size and topology of the maps, initialize the set of reference vectors mᵢε [symbol] ⁿ,i=1,2, . . . ,k by setting them randomly, or for instance, choose the first k copies of the first training vectors x.

2. Find the BMU for the input vector x(t), and adjust the reference vectors of BMU and its neighborhood units.

3. Repeat step 2, until the changes of reference vectors are not significant.

A batch computation algorithm of SOMs (Batch Map) is also available if all the training samples are assumed to be available when learning begins. It resembles the K-means algorithms for VQ, particularly at the last phase of the learning process when the neighborhood N_{c}(t) shrinks to a set only containing the BMU. This Batch Map algorithm contains no learning rate factor, thus has no convergence problems and yields more stable values for the reference vectors mᵢε [symbol] ⁿ,i=1,2, . . . ,k .

Different learning process parameters, initialization of the reference vectors mᵢ(0)ε [symbol] ⁿ,i=1,2, . . . , k, and sequence of training vectors x(t) can result in different maps. Depending on the criterion of optimality, different SOMs can be considered optimal, for example, the average quantization error. The average quantization error, which is the mean of ∥x−m_{c}∥, is a meaningful performance index that can measure how well the map is fitted to the set of training samples. Further information regarding SOMs can be found in the following references, and the references therein, all of which are incorporated herein by reference:
Kohonen, T., Oja, E., Simula, O., Visa, A., Kangas, J. (1996), “Engineering applications of the self-organizing map”, Proceedings of the IEEE, v 84, n 10, p 1358-1384
Kohonen, T. (11995), Self-Organizing Maps. Springer, Berlin, Heidelberg.

Increasingly complex and sophisticated control software, integrated sensors, actuators, and microelectronics provide customers with higher reliability, safety and maintainability. However, these impose more challenges than ever for today's engineers to diagnosis the vehicle and to detect and isolate system anomalies. The increasing portion of control software on a vehicle makes it even more difficult, because in order to reduce the cost, most of the manufacturers prefer the solution of designing more sophisticated control software, instead of adding hardware, to provide attractive features. The amount of software operating on a vehicle is unlikely to stop growing in the future.

The control software and various hardware components used on the vehicle usually exhibit nonlinear behaviors. This is especially true for control software. Therefore, once these software and hardware components are integrated in a vehicle and communicate with each other, they create a large number of operational regions. Those interactions are sometimes too complicated to understand even for experienced engineers. In addition, the driver inputs and external environmental conditions vastly vary and create infinite patterns of conditions in which the vehicle operates. Signatures describing system behaviors for different driver inputs and external influences are quite different. With infinitely many behavioral patterns, anomaly detection and localization are complex, because one has to compare the behavioral signatures to appropriate behavioral regimes. The best way to find anomalies is to compare the signatures within the same behavior regime, and the deviation of the current signature from a normal signature is the indication of the severity of the anomalies.

To partition the system dynamic behaviors into different operational regions, or regionalization, one first has to find an appropriate base on which the regionalization can be conducted. Variety of the physical system, such as mechanical, electrical, electromechanical, thermal, and hydraulic systems, can be modeled by ordinary differential equations of the following form,
F(t,y,y′,y″, . . . ,y⁽ⁿ⁾,u₁,u₂, . . . ,uₚ,u′₁,u′₂, . . . ,u′ₚ, . . . ,u₁^{(m)},u₂^{(m)}, . . . uₚ^{(m)})=0
where y′₁, y″₁, . . . y⁽ⁿ⁾ is the first, second and up to n^{th} order derivatives of the system output, u₁,u₂, . . . ,uₚ,u′₁,u′₂, . . . ,u′ₚ, . . . ,u₁^{(m)},u₂^{(m)}, . . . uₚ^{(m)} and are the inputs and their derivatives up to m^{th} order. If the inputs have been specified as piecewise differentiable function of time, u=μ(t) where u=[u₁,u₂, . . . ,uₚ], then one can substitute u=μ(t) to eliminate u and its derivatives yields:
F(t,y,y′,y″, . . . ,y⁽ⁿ⁾)=0
y⁽ⁿ⁾ can be expressed explicitly, i.e. y⁽ⁿ⁾=γ(t, y, y′, y″, . . . ,y⁽ⁿ⁻¹⁾). If one chooses the state variables as follows x₁=y,x₂=y′, . . . ,xₙ=y⁽ⁿ⁻¹⁾, the formula can be written as a set of state space equations
\dot{x}ᵢ=x₂
\dot{x}₂=x₃
. .
. .
. .
\dot{x}ₙ=γ(t,y,y′, y″, . . . ,y⁽ⁿ⁻¹⁾)
y=x₁

This can be rewritten as the set of n first order differential equations as a one n-dimensional first order vector differential equation:
\dot{x}=f(t,x),xεⁿ

It has been proven in Khalil, H. (2002), Nonlinear Systems, 3^{rd} edition. Prentice-Hall, N.J., which is herein incorporated by reference, that if f(t, x) is piece-wise continuous in t and satisfies the Lipschitz condition:
∥f(t,x)−f(t,y)∥≦L∥x−y∥
∇x,yε [symbol] ⁿ, ∇tε[t₀,t₁], where L is a finite positive number, then the state equation \dot{x}=f(t,x), xε [symbol] ⁿ with initial condition x(t₀)=x₀ has a unique solution over [t₀, t₁]. This is called the global existence and uniqueness theorem. This can be easily generalized into multiple inputs and multiple output systems.

If certain conditions are satisfied, the initial conditions of output y up to (n−1)^{th} order derivatives and input sequences during time interval [t₀, t₀+τ], can uniquely determine the system output y over the same time interval. This gives us an indication that the regionalization can be based on the initial conditions of output and input sequences.

A tremendous number of system behavior patterns impose a great challenge on anomaly detection and localization, or regionalization. Traditional model-based faults diagnosis techniques are unsuitable for many cases, since detailed knowledge about the underlying physical system is not available. The system can only be viewed as a black box. Some available techniques that can deal with black-box problems either have strict parametric assumptions or lack of real time implementability, such as nonlinear autoregressive moving average modeling and neural networks. Therefore, there is a need to find a way that can approximately build a model that relates the system inputs and outputs. Preferably, the system is partitioned into different regions, based on the inputs sequences and initial conditions of outputs.

If we concatenate the initial conditions of the outputs including

$$y ( {t}_{0} ) , \frac{ⅆ y}{ⅆ t} {\vert}_{t = {t}_{0}} , \frac{{ⅆ}^{2} y}{ⅆ {t}^{2}} {\vert}_{t = {t}_{0}} , … , \frac{{ⅆ}^{n} y}{ⅆ {t}^{n}} {\vert}_{t = {t}_{0}}$$

and the input sequences u(t) during a certain time interval [t₀, t₁] together to form a big vector as follows:

$${[ y ( {t}_{0} ) , \frac{ⅆ y}{ⅆ t} {\vert}_{t = {t}_{0}} , \frac{{ⅆ}^{2} y}{ⅆ {t}^{2}} {\vert}_{t = {t}_{0}} , … , \frac{{ⅆ}^{n} y}{ⅆ {t}^{n}} {\vert}_{t = {t}_{0}} , u ( {t}_{0} ) , … , u ( {t}_{0} + τ ) ]}^{T}$$

where

$$y ( {t}_{0} ) = [ {y}_{1} ( {t}_{0} ) , … , {y}_{q} ( {t}_{0} ) ] , \frac{ⅆ y}{ⅆ t} {\vert}_{t = {t}_{0}} = [ \frac{ⅆ {y}_{1}}{ⅆ t} {\vert}_{t = {t}_{0}} , … , \frac{ⅆ {y}_{q}}{ⅆ t} {\vert}_{t = {t}_{0}} ]$$

and so on. This vector contains all the information necessary to determine the system outputs. However, in real applications, this vector usually has a very high dimension. Therefore, SOMs is used to regionalize the space spanned by those vectors, because of its excellent capability of visualization of high dimensional data. The Voroni sets use all the reference vectors of the trained SOM, then form a partition of the entire space spanned by the vectors. The Voroni set is referred to as a system “operational region”.

Since each of the regions has similar inputs and initial conditions, the output sequences in the same operational region will have similar patterns. Based on these outputs patterns, one can create a statistical profile for each of the operational regions that represent the normal system behavior. After regionalization, based on input patterns and initial conditions of outputs, one can allocate the signal into an appropriate region by finding the BMU, and within each region compare the current output sequence with the normal profile. A statistical dissimilarity measure between the current output sequence and the normal profile can be used as a performance index that indicates how far the system behavior deviates from the normal or expected behavior. This can be realized through time frequency analysis based performance assessment.

Time frequency analysis (TFA) has long been recognized as a powerful non-signal processing method and has been widely applied into different areas, such as radar technology, marine biology, and biomedical engineering. Unlike the well-known Fast Fourier Transform (FFT) that can only decompose the signal into frequency components, but does not depict the time location related information, TFA is capable of decomposing the signal into both time and frequency simultaneously. This makes TFA an appropriate method to analyze signals, in which the frequency contents of the signal change over time. For example, it is very difficult to detect a time delay in a control system if one uses FFT, but it is an easier task using TFA. Capable of dealing with non-stationary signals makes TFA quite suitable to process signals from control systems.

Consider a two-dimensional distribution p_{X,Y}(x, y), whose characteristic function is given by:
φ(η,ξ)=E[e^{jXη+jYξ}]=∫∫e^{jxη+jyξ}p_{X,Y}(x,y)dxdy

It can be approximated by a Taylor series, Cohen, L. (1994), Time-Frequency Analysis, Prentice Hall, incorporated herein by reference, and the characteristic function can be expressed as

$$ϕ ( η , ξ ) = {\sum }_{p + q = 0}^{N} \frac{{j}^{p + q}}{p ! q !} E ( {X}^{p} {Y}^{q} ) {η}^{p} {ξ}^{q} + o [ {( {η}^{2} + {ξ}^{2} )}^{\frac{n}{2}} ]$$

Since the time frequency distribution can be uniquely determined by its characteristic function, the sequence of moments E(X^{p}Y^{q}) can be used to describe the distribution P_{X,Y}(x, y).

However, the moment sequence is infinitely long and hence cannot be directly used as features. Furthermore, moments of different orders are highly correlated with each other. Nevertheless, only moments of the lower order describe the general properties of the time frequency distribution, and hence we can truncate the moment sequence in order to approximately represent a time frequency distribution. Therefore, further processing is necessary to reduce the dimensionality of the moment vector. This can be achieved through Principal Component Analysis (PCA), Richard, O. Duta, P., David G. (2000), Pattern Classification, Wiley, 2^{nd} edition, incorporated herein by reference, since the time frequency moments can be assumed to be asymptotically Gaussian, Zalubas, E. J., O'Neill, J. C., Williams, W. J. and Hero, A. O., “Shift and Scale Invariant Detection,” in Proc. IEEE Int. Conf. Acoustic, Speech, and Signal Processing, vol. 5, 1996, pp. 3637-3640, incorporated herein by reference.

Assuming Gaussianity and independence of the principle components, the Mahalanobis distances between feature vectors are asymptotically following the χ² distribution with r degrees of freedom, where r is the number of extracted principal components. Therefore, the deviation of the signals from the training set, which represents the normal distribution, can be measured by the probability that the Mahalanobis distance is within a certain range. This probability is referred to as a confidence value (CV) indicating the degree of the deviation from normal state. For more detailed information, see Djurdjanovic, D., Widmalm, S. E., Willians, W. J., Koh, C. K. H. and Yang, K. P. (2000), “Computerized Classification of Temporomandibular Joint Sounds”, IEEE transaction on biomedical engineering, vol. 47, No. 8, herein incorporated by reference.

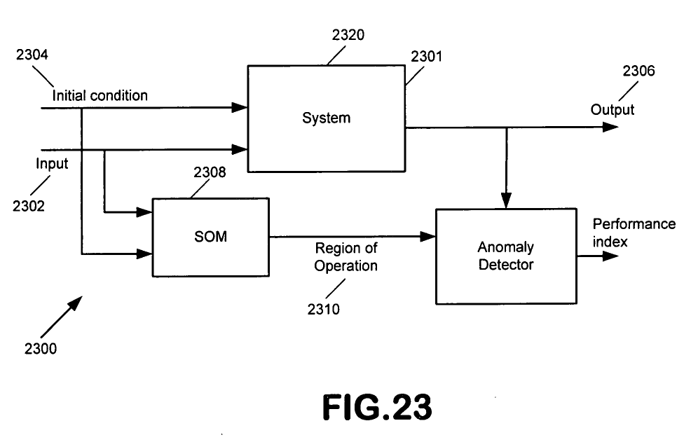

FIG. 23 illustrates a diagnostic system 2300 for which the performance can be evaluated, according to an example embodiment. A system 2301 includes inputs 2302, initial conditions 2304, and outputs 2306. Regionalization can be accomplished using a SOM 2308 based on the inputs 2302 and initial conditions 2304. A TFA-based performance assessment technique can be directly applied within operational regions 2310 based on a current output sequence. An assumption is made that no knowledge about the model or structure of the system 2301 is available. The only assumption is that the inputs 2302 and outputs 2306 are available when the system 2301 is operating normally.

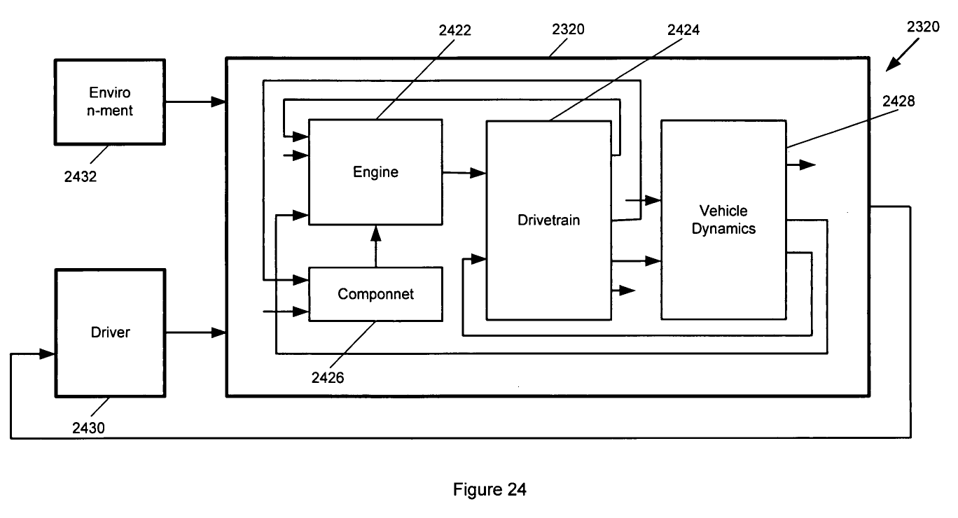

Preferably, the system 2301 is a vehicle 2320; however, the system 2320 can be any suitable system. FIG. 24 illustrates the vehicle 2320 in more detail. The vehicle 2320 includes an engine 2422, a drivetrain 2424, other components 2426, and vehicle dynamics 2428. A driver 2430 can provide inputs 2302 into the system 2301, FIG. 23. An environment 2432 also provides inputs 2302 into the system 2301, FIG. 23, such as temperature, wind speed, road slope, and atmospheric pressure.

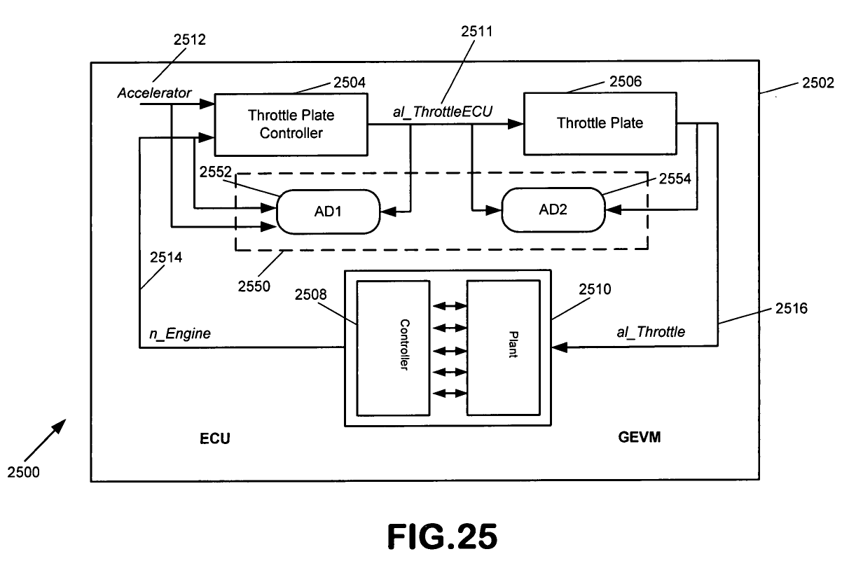

To apply the anomaly detection technique described herein to the vehicle 2320, the vehicle 2320 must be regionalized into a first subsystem 2500, FIG. 25. In an example embodiment, the first subsystem 2500, or regionalized system, is a throttle plate subsystem 2502. The throttle plate subsystem 2502 includes a throttle plate controller 2504, a throttle plate 2506, a controller 2508 and a plant 2510.

The input, for example, the inputs 2302 of FIG. 23, to the throttle plate subsystem 2502 is a control signal 2511 from the throttle plate controller 2504, which regulates a throttle plate angle 2516 in the throttle plate 2506. The actual throttle angle is measured by sensors and fed back into the integrated system 2500. There are two inputs to the throttle plate controller 2504 when the vehicle 2320 is operating: a relative accelerator position 2512 and an engine speed 2514. Based on these two inputs 2512, 2514, the throttle plate controller 2504 calculates the control signal 2511 and sends it back to the throttle plate 2506 that sets the absolute throttle angle 2516.

An anomaly detection system 2550 detects the gradual parameter degradation of either the plant (throttle mechanism) 2510 or the controller 2508, as the system 2502 is operating. Moreover, the anomaly detection system 2550 should be able to locate any anomalies, whether the anomalies happen in the controller 2508 or in the plant 2510. Preferably, the anomaly detection system 2550 includes a first anomaly detector 2552 and a second anomaly detector 2554. The first anomaly detector 2552 detects anomalies on the control side while the second anomaly detector 2554 detects anomalies on the plant side.

The relative accelerator signal (Accelerator) 2512, the engine speed (n_Engine) 2514, the control signal (al_ThrottleECU) 2511, and the absolute throttle angle (al_Throttle) 2516, are sampled frequently, preferably every 5 milliseconds, which corresponds to a sampling rate of approximately 200 Hz. Preferably, these signals are then downsampled by two to reduce the sampling rate to 100 Hz.

The relative accelerator signal (Accelerator) 2512, the engine speed (n_Engine) 2514, the control signal (al_ThrottleECU) 2511, and the absolute throttle angle (al_Throttle) 2516 are first collected as the vehicle 2320 operates under normal conditions, or as determined in an IDE, for example, the IDE 500 of FIG. 5.

The following table illustrates the training and testing data sets:

| | Name of test cycles |
|---|---|
| Training data set | Japan15 & Japan 11: Japanese cycles |
| | FTP72: USA (Federal Test Procedure of 1972) |
| | Manual driving profiles |
| Testing data set | FTP75: USA (Federal Test Procedure of 1975) |
| | ECE2: New European Test Cycle of the ECE |

The following illustrates the mechanical throttle plate 2506 within the vehicle 2320:

[image]

The input to the subsystem 2500 is labeled as al_ThrottleECU 2511, which is the control signal 2511 coming from the throttle plate controller 2504, usually ranging from 0˜1. By varying the al_ThrottleECU signal 2511, one can regulate the output of the throttle plate 2506, labeled as al_Throttle 2516, which is the absolute throttle angle with respect to the stop, as shown above. Two parameters al_ThrottleMin and al_ThrottleDelta define the range that the throttle plate 2506 can open. The dynamics of the throttle plate 2506 are modeled as a second order dynamic system with three parameters: the mass M, the viscous damping coefficient C and the stiffness K. The nominal values for the parameters of this throttle plate 2506 are M=1, C=10, K=40, al_ThrottleDelta=80 and al_ThrottleMin=8.

The following figure illustrates the signals that are collected when all the parameters of throttle plate 2506 are set to the nominal values:

[image]

$$\begin{matrix}[ \begin{matrix}y ( {t}_{0} ) \\ \frac{ⅆ y}{ⅆ t} {\vert}_{t = {t}_{0}} \\ \frac{{ⅆ}^{2} y}{ⅆ {t}^{2}} {\vert}_{t = {t}_{0}} \\ ⋮ \\ u ( {t}_{0} ) \\ ⋮ \\ u ( {t}_{0} + τ )\end{matrix} ] & ⋯ & [ \begin{matrix}y ( {t}_{1} ) \\ \frac{ⅆ y}{ⅆ t} {\vert}_{t = {t}_{1}} \\ \frac{{ⅆ}^{2} y}{ⅆ {t}^{2}} {\vert}_{t = {t}_{1}} \\ ⋮ \\ u ( {t}_{1} ) \\ ⋮ \\ u ( {t}_{1} + τ )\end{matrix} ] & ⋯ \\ [ \begin{matrix}y ( {t}_{0} ) \\ ⋮ \\ y ( {t}_{0} + τ )\end{matrix} ] & ⋯ & [ \begin{matrix}y ( {t}_{1} ) \\ ⋮ \\ y ( {t}_{1} + τ )\end{matrix} ] & ⋯\end{matrix}$$

As described above, system dynamic behaviors are partitioned into different operational regions, and within each of the regions training is necessary to establish the statistical normal profile using the output sequences. This training information can be information learned from the IDE, for example IDE 500 of FIG. 5, through the DRD link 599. The regionalization for this throttle plate subsystem 2500 is based on the initial conditions of output, which is the absolute throttle angle (al_Throttle) 2516, and the input sequences, which is the control signal 2511 from the throttle plate controller 2504, al_ThrottleECU 2511.

al_ThrottleECU is denoted as u and al_Throttle is denoted as y. To include all the information about initial conditions of output and input, we concatenate them together into a big feature vector as

$${[ y ( {t}_{0} ) , \frac{ⅆ y}{ⅆ t} {\vert}_{t = {t}_{0}} , \frac{{ⅆ}^{2} y}{ⅆ {t}^{2}} {\vert}_{t = {t}_{0}} , … , u ( {t}_{0} ) , … , u ( {t}_{0} + τ ) ]}^{T} ,$$

where

$$y ( {t}_{0} ) , \frac{ⅆ y}{ⅆ t} {\vert}_{t = {t}_{0}} , \frac{{ⅆ}^{2} y}{ⅆ {t}^{2}} {\vert}_{t = {t}_{0}} , …$$

are the initial value, 1^{st} derivative, and 2^{nd} derivative etc. of the system output. u(t₀), . . . , u(t₀+τ) is the input sequence during time interval [t₀,t₀+τ]. The corresponding output sequence is [y(t₀), . . . ,y(t₀+τ)]^{T}. Similarly, one can shift the window of length τ to another start point t₁, giving another big feature vector

$${[ y ( {t}_{1} ) , \frac{ⅆ y}{ⅆ t} {\vert}_{t = {t}_{1}} , \frac{{ⅆ}^{2} y}{ⅆ {t}^{2}} {\vert}_{t = {t}_{1}} , … , u ( {t}_{1} ) , … , u ( {t}_{1} + τ ) ]}^{T}$$

and its corresponding output sequence [y(t₁), . . . , y(t₁+τ)]^{T} as illustrated. In this way, two sets of vectors are collected: one containing all the information of the initial conditions of the output together with the input sequence, and the other consisting of the output sequence of the same time interval. Moreover, there is a one-to-one correspondence between these two sets of feature vectors.

Only the signals with highly dynamic inputs are used for training and are later used for testing. Relatively static inputs do not simulate dynamic modes of the system and hence cannot reveal faults caused by dynamic system parameter drifts. Therefore, to detect the gain change as well as dynamic change of the system, the training set of only rapidly changing signals is used. One possible way is to set a threshold on the variance of the input sequences. Only the input sequences whose variances are greater than the predefined threshold are selected as a training set. Although this may not be the optimal way, it is easier to implement.

After collecting all the feature vectors, regionalization can be done using SOM based on the vectors consisting of input sequence and initial conditions of output. In this example embodiment for the throttle plate subsystem 2502, a data sequence length is chosen as 0.6 seconds, which corresponds to 60 points after the original data has been downsampled by two, as described above. For the initial conditions of output, only the initial value, and the first and second derivatives are included. Since the input to the throttle plate subsystem 2502 is a number from 0˜1, no normalization is necessary for the input sequence. The initial conditions of the output, including the initial value, and the first and second derivatives, has been normalized using the following formula:

$${X}_{normalized} = \frac{X - E ( X )}{{σ}_{X}}$$

where E(X) and σₓ are the mean and the deviation of variable X. This step is necessary to eliminate the situation in which there is huge magnitude of difference in the feature vector elements, because the features of big magnitude will dominate the effects on the resulting SOM. An example software package that can be used is SOM Toolbox, Alhoniemi, E., Himberg, J., Kiviluoto, K., Parviainen, J. and Vesanto, J. (1997), SOM toolbox for Matlab, available via WWW at fttp://www.cis.hutfi/somtoolbox/

The size of SOM is determined using a heuristic formula embedded inside the software based on the size of training vectors available. There is a trade-off between a degree of generalization and quantization accuracy of SOM. A small SOM has good generalization of the training feature vectors but poor quantization accuracy. A large SOM can have high quantization accuracy, but the training feature vectors are not well generalized, and it consumes more computation power. The SOM obtained from the concatenated feature vector of input and initial conditions of output, along with the unified distance matrix is illustrates as:

[image]

The SOM created is based on the feature vectors obtained by concatenating the system input and initial conditions of output and the unified distance matrix.

Once the SOM training is finished using normal data, the normal training output sequences can then be allocated to the region whose associated prototype feature vector is nearest to the corresponding concatenated feature vector of input and initial conditions. The TFA is then applied on the normal training output sequences in each of the regions and the moment sequences are extracted.

Based on the time frequency distribution, the moments are calculated up to an order of fifteen, i.e. p+q≦15. This results in the moment sequence of dimension 135. To reduce the dimensionality of the obtained moment sequences, PCA is applied on these moment sequences within each of the regions to further compress the high dimensional moment sequences. Finally, only 2˜3 principle directions, along which 99% of the total variance of the original moment sequences project, as well as their corresponding variances, are preserved as parameters for later testing. In order to make sure the training is adequate and to keep high detection accuracy, only the regions that have been frequently activated during training are selected, and within each of them the training is conducted based on the procedure described above.

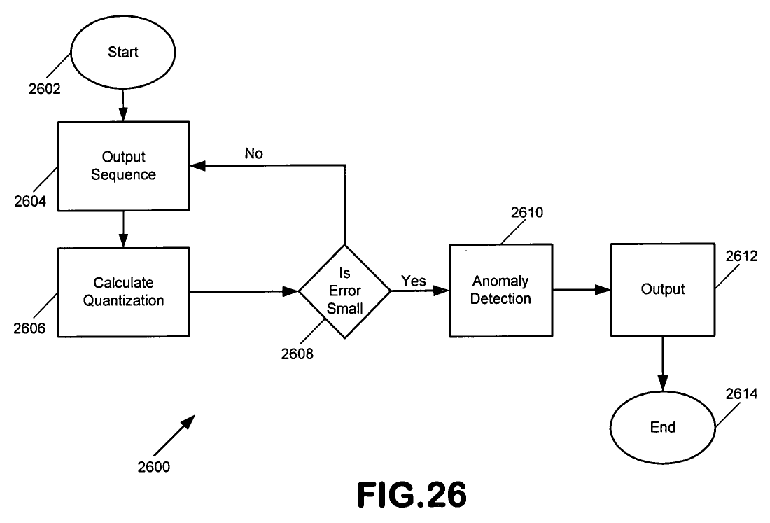

FIG. 26 illustrates a logical flow diagram of an anomaly detector 2600. Operational flow begins at a start terminal 2602. An output operation 2604 allocates a current output sequence, and its corresponding inputs and initial conditions, into an operational region, whose codeword vectors are nearest a concatenated feature vector, for any new signals coming in, based on the concatenated feature vector of current input sequence and initial conditions. A calculate operation 2606 calculates a quantization error.

An error module 2608 determines if the quantization error is smaller than a preset threshold, which is the median of the quantization errors during training. If the error module 2608 determines that the quantization error is smaller, operational flow branches “YES” to the output operation 2604. If the error module 2608 determines that the quantization error is not smaller, operational flow branches “NO” to an anomaly operation 2610 and an anomaly detector is triggered. The anomaly detector will automatically retrieve the trained parameters of the specified region and calculate the cumulative probability of the Mahalanobis distance specified by the moment sequence calculated from the current output sequence, according to χ² distribution. An output operation 2612 outputs a performance index having a confidence value ranging from 0˜1, which measures the deviation of the system behavior from normal. Operational flow ends at terminal point 2614.

The following figure illustrates some example results of the anomaly detector on the throttle plate subsystem 2502:

[image]

The horizontal axis shows the system parameter values, and each point represents the mean of confidence values when the system parameter is set to the specified value as indicated in along x axis. In addition, the 3-σ limits are also illustrated as intervals made of short solid lines. As discussed herein previously, the nominal values for viscous damping coefficient C and stiffness K are 10 and 40 respectively. It can be observed that as the parameters degrade away from the nominal value, the confidence value drops down. This in turn provides an indication that the system performance is deviating away from the normal behaviors. Similar trends have also been observed for the other two parameters, the mass M and the ThrottleDelta. This indicates the anomaly detector is capable of detecting different kinds of anomalies and the gradual degradation of the system parameters without a priory presenting signatures characterizing those faults to the anomaly detector.

Unlike the throttle plate 2506, FIG. 25, where there is only one input, the throttle plate controller 2504 has two inputs: Accelerator 2512 and n_Engine 2514. A parameter can be introduced into the throttle plate controller 2504 to scale one of the tables in the nonlinear throttle plate controller 2504. The nominal value for this gain factor is 1 and the following figure illustrates the sample signals collected when the gain factor is set to its nominal value:

[image]

Like the anomaly detection on the plant, a similar procedure can also be applied here. The data length is taken as 0.8 seconds, which corresponds to 80 data points. The vector on which regionalization is based is the vector that consists of concatenated two input sequences from Accelerator 2512 and n_Engine 2514 and the initial conditions of the output al_ThrottleECU 2511. After proper normalization of this feature vector, a SOM has been created based on the training data to regionalize the system dynamics behaviors. Then TFA and PCA are utilized to establish the normal statistical profile for each region.

After the training is complete, the controller detector has been tested on the testing data. The following figure illustrates the results from the anomaly detector associated with the controller:

[image]

It can be observed that as the gain factor of the controller is reduced from its nominal value of 1 to 0.65, the confidence value decreases, however the variance increases.

Individual anomaly detectors are capable of sensing gradual degradations of system parameters. If we combine the results from different anomaly detectors, we can also locate the anomalies. To demonstrate this capability, two scenarios are discussed. In the first scenario, the stiffness K, which is a parameter of the plant, is made to gradually decrease from the nominal value 40 to 24 in about 700 seconds. Other parameters including parameters of the controller and the plant, are kept at their nominal values. In the second scenario, disturbance is introduced to the gain factor, which is a parameter of the controller, and is also made to exponentially decrease from the nominal value 1 to 0.6 in about 700 seconds. The following illustrates the time varying parameters in the two scenarios.

[image]

The two anomaly detectors discussed previously are then tested on standard driving profiles, which are not used for training. The first scenario is tested on a first driving profile ECE2, and the second scenario is tested on a second driving profile FTP75. These two particular driving profiles correspond to driving profiles within LABCAR®, a product of ETAS. The following illustrates the anomaly detection results.

[image]

[image]

In order to filter out the noise, the exponential weighted moving average (EWMA) operator is applied to the confidence values. The straight line across the window is the lower control limit that has been calculated based on the statistics of the confidence values observed on the training data set.

It can be observed, that for the first scenario, the confidence values from the controller are high all the time, but the confidence values from the anomaly detector on the plant gradually decrease and finally go out of the control limits. This indicates that an anomaly occurred in the plant but the controller is still operating normally. For the second scenario, since disturbance was introduced into the controller parameter, the confidence values from the controller anomaly detector decrease and go out the control limits, while the confidence values from the plant anomaly detector remain within the control limit. Thus, one can easily determine the location of the anomalies, in the controller, the plant, or both. The ability to decouple plant and controller anomalies as demonstrated is important for finding the locations of the anomalies.

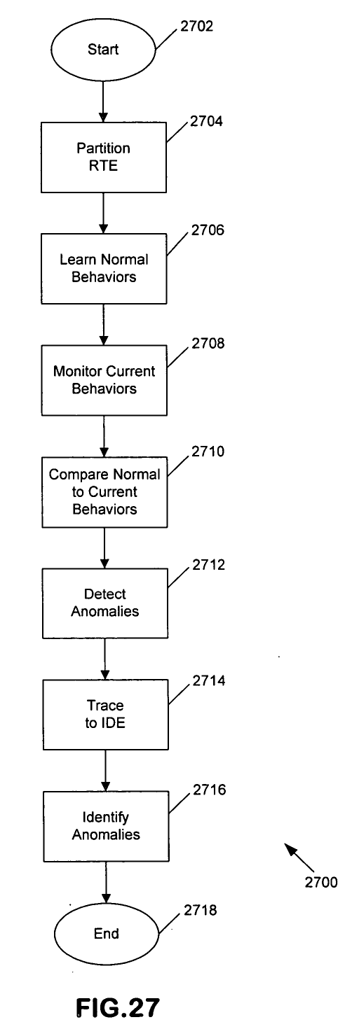

FIG. 27 is an example flow diagram of an anomaly detection system 2700. Operational flow begins at a start point 2702. A partition operation 2704 partitions a run-time environment into at least one operational region. This partitioning can be called regionalization. A learn operation 2706 learns normal behaviors operating within the operational region. This learning can be called training. A monitor operation 2708 monitors current behaviors. A compare operation 2710 compares the normal behaviors to the current operating behaviors. A detect operation 2712 detects anomalies when a deviation exists between the current operating behaviors and the normal operating behaviors. A trace operation 2714 traces the anomalies back to an integrated development environment through a link. An identify operation 2716 identifies the anomalies in the integrated development environment based on the tracing of the anomalies.

As discussed herein, a novel anomaly detection scheme that is capable of detecting the gradual degradation of the performance of a controlled system and of localizing the anomalies is disclosed. Unlike traditional model-based fault diagnosis, the proposed approach does not require detailed knowledge of the system dynamics. The existence of normal inputs and outputs signals is the only assumption for the proposed method.

This approach is capable of building the input-output relationship statistically through SOM based regionalization and TFA based performance assessment using the normal input-output signals, regardless of system type, linear or nonlinear. The model building process is quite efficient. This significantly reduces the development time of the diagnostic system.

The disclosed method has been demonstrated on a subsystem of a gasoline engine vehicle model. It has been shown that the anomaly detector can detect different kinds of parameter drifts of the system. Moreover, the two anomaly detectors can decouple the plant and controller anomalies. Based on the results of the anomaly detectors, one can localize the anomalies in the plant, controller, or both.

One skilled in the art would recognize that the system described herein can be implemented using any number of software configurations, network configurations, hardware configurations, and the like.

The logical operations of the various embodiments illustrated herein are implemented (1) as a sequence of computer implemented steps or program modules running on a computing system and/or (2) as interconnected logic circuits or circuit modules within the computing system. The implementation is a matter of choice dependent on the performance requirements of the computing system implementing the invention. Accordingly, the logical operations making up the embodiments of the present invention described herein are referred to variously as operations, steps, engines, or modules.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A system for detecting anomalies, the system comprising:
a first hardware system that generates outputs;
a first run-time environment having a bi-directional link to an integrated development environment, the first run-time environment including:
a first control system that controls the hardware system through control inputs to the hardware system;
a first diagnostic agent for detecting anomalies in the hardware system; and
a second diagnostic agent for detecting anomalies in the control system;
wherein the first and second diagnostic agents can detect anomalies by detecting gradual degradation of the performance of the system by comparing current operating behavior to normal operating behavior within the first run-time environment and tracing the anomalies back to the integrated development environment through the bi-directional link.

2. A system according to claim 1, wherein:
the integrated development environment includes a collection of software and hardware development tools operating within the integrated development environment that enable deployment of the first and second diagnostic agents into the run-time environment.

3. A system according to claim 1, further comprising:
a second hardware system that generates outputs;
a second run-time environment having a bi-directional link to the integrated development environment, the second run-time environment including:
a second control system that controls the hardware system through control inputs to the hardware system;
a third diagnostic agent for detecting anomalies in the hardware system; and
a fourth diagnostic agent for detecting anomalies in the control system;
wherein the third and fourth diagnostic agents can detect anomalies by detecting gradual degradation of the performance of the system by comparing current operating behavior to normal operating behavior within the second run-time environment and tracing the anomalies back to the integrated development environment through the bi-directional link.

4. A system according to claim 1, wherein:
the bi-directional link includes a development run-time development link that is associated with a combination of data-bases and message passing to contain configuration data produced by the integrated development environment and pass the configuration data to the first run-time environment for deployment of the first and second diagnostic agents in the first run-time environment.

5. A system according to claim 4, wherein:
the bi-directional link receives the anomalies from the first run-time environment and passes the anomalies to the integrated development environment.

6. A system according to claim 1, wherein:
the first diagnostic agent includes a plurality of first diagnostic agents; and
the second diagnostic agent includes a plurality of second diagnostic agents.

7. A system according to claim 1, wherein:
the first run-time environment includes a plurality of run-time environments.

8. A method of detecting anomalies in a system including an integrated development environment and a run-time environment bi-directionally linked by a link, the method comprising:
partitioning the run-time environment into at least one operational region;
learning normal operating behaviors within the operational region;
monitoring current operating behaviors within the operational region during operation of the system;
comparing the current operating behaviors to the normal operating behaviors;
detecting anomalies when a deviation exists between the current operating behaviors and the normal operating behaviors;
tracing the anomalies back to the integrated development environment through the link; and
identifying the anomalies in the integrated development environment based on the tracing of the anomalies.

9. A method according to claim 8, wherein:
partitioning the system includes partitioning the system using self-organized maps into at least one operational region.

10. A method according to claim 9, wherein:
partitioning the system includes automated partitioning of the system using self-organized maps into at least one operational region.

11. A method according to claim 8, wherein:
detecting anomalies includes detecting anomalies using time-frequency analysis.

12. A method according to claim 11, wherein:
detecting anomalies includes detecting anomalies with high statistical accuracy using extensions to time-frequency analysis that recognize statistical deviations from the normal operating behaviors.

13. A method according to claim 8, wherein:
partitioning the system includes partitioning the system into at least one operational region called regionalization.

14. A method according to claim 8, wherein:
learning normal operating behaviors includes learning normal operating behaviors within the operational region called training.

15. A method according to claim 8, further comprising:
recognizing the operational region in the integrated development environment.

16. A method according to claim 8, wherein:
partitioning the system includes partitioning the system into at least one operational region that can be observed by a single anomaly detector.

17. A method according to claim 8, wherein:
identifying the anomalies in the integrated development environment based on the tracing of the anomalies includes identifying root causes of the anomalies in the integrated development environment based on the tracing of the anomalies.

18. A system for detecting anomalies in a system including an integrated development environment and a run-time environment bi-directionally linked by a link, the system comprising:
a partition module that partitions the run-time environment into at least one operational region;
a learn module that learns normal operating behaviors within the operational region;
a monitor module that monitors current operating behaviors within the operational region during operation of the system;
a compare module that compares the current operating behaviors to the normal operating behaviors;
a detect module that detects anomalies when a deviation exists between the current operating behaviors and the normal operating behaviors;
a tracing module that traces the anomalies back to the integrated development environment through the link; and
an identify module that identifies the anomalies in the integrated development environment based on the tracing of the anomalies.

19. A system according to claim 18, wherein:
the partition module uses self-organized maps.

20. A system according to claim 18, wherein:
the detect module uses time-frequency analysis.

21. A system according to claim 18, wherein:
the partition module partitions the system into at least one operational region that can be observed by a single anomaly detector.

22. A computer program product readable by a computing system and encoding instructions diagnosing model errors in a system including an integrated development environment and a run-time environment bi-directionally linked by a link, the computer process comprising:
partitioning the run-time environment into at least one operational region;
learning normal operating behaviors within the operational region;
monitoring current operating behaviors within the operational region during operation of the system;
comparing the current operating behaviors to the normal operating behaviors;
detecting anomalies when a deviation exists between the current operating behaviors and the normal operating behaviors;
tracing the anomalies back to the integrated development environment through the link; and
identifying the anomalies in the integrated development environment based on the tracing of the anomalies.

23. A computer program product according to claim 22, wherein:
partitioning the system includes partitioning the system using self-organized maps into at least one operational region.

24. A computer program product according to claim 23, wherein:
partitioning the system includes automated partitioning of the system using self-organized maps into at least one operational region.

25. A computer program product according to claim 22, wherein:
detecting anomalies includes detecting anomalies using time-frequency analysis.

26. A computer program product according to claim 25, wherein:
detecting anomalies includes detecting anomalies with high statistical accuracy using extensions to time-frequency analysis that recognize statistical deviations from the normal operating behaviors.

27. A computer program product according to claim 22, wherein:
partitioning the system includes partitioning the system into at least one operational region called regionalization.

28. A computer program product according to claim 22, wherein:
learning normal operating behaviors includes learning normal operating behaviors within the operational region called training.

29. A computer program product according to claim 22, further comprising:
recognizing the operational region in the integrated development environment.

30. A computer program product according to claim 22, wherein:
partitioning the system includes partitioning the system into at least one operational region that can be observed by a single anomaly detector.

31. A computer program product according to claim 22, wherein:
identifying the anomalies in the integrated development environment based on the tracing of the anomalies includes identifying root causes of the anomalies in the integrated development environment based on the tracing of the anomalies.
